(19) United States
(12) Patent Application Publication
(10) Pub. No.: US 2007/0040871 A1
(43) Pub. Date: Feb. 22, 2007

(54) Drive control device for a piezoelectric actuator, electronic device, and drive control method for a piezoelectric actuator

(75) Inventor: Osamu Urano, Okaya-shi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/506,829

(22) Filed: Aug. 21, 2006

(30) Foreign Application Priority Data
Aug. 22, 2005 (JP) JP 2005-240013
May 19, 2006 (JP) JP 2006-140248

(51) Int. Cl. B41J 2/045

(52) U.S. Cl. 347/68

(57) ABSTRACT

A piezoelectric actuator drive control device, electronic device, and piezoelectric actuator drive control method simplify the arrangement of the control circuitry, and enable easily controlling driving a driven body and piezoelectric actuator current. A PWM signal source outputs a variable pulse width control pulse signal B to change the ratio between the periods t-n and t-w when pulse width Nr and pulse width Wd are selected as the pulse width of the drive pulse signal I. This enables the drive control device to freely control the rotor speed and to freely control current flow to the piezoelectric actuator. This arrangement simplifies drive control and eliminates the difficulty of limiting the pulse width and frequency that occurs when directly controlling the drive signal pulse width and frequency.

### BACKGROUND

1. Technical Field

The present invention relates to a drive control device for a piezoelectric actuator, an electronic device, and a drive control method for a piezoelectric actuator.

2. Related Art

Piezoelectric devices feature outstanding response and efficiency converting electrical energy to mechanical energy. This has resulted in the development of piezoelectric actuators that use an oscillator having a piezoelectric device to drive a rotor or other driven body by transferring vibration from the oscillator to the driven body. Piezoelectric actuators are used in cameras, printers, electronic timepieces, toys, and other types of electronic devices, and their use in other applications is expected to continue growing.

A voltage amplitude control drive method (see, for example, Japanese Unexamined Patent Appl. Pub. H4-222476) and a PWM (pulse width modulation) drive method (see, for example, Japanese Unexamined Patent Appl. Pub. H4-133667) can be used for piezoelectric actuator current control and to control how much the driven body is driven (speed control).

See particularly paragraph [0011] in Japanese Unexamined Patent Appl. Pub. H4-222476A, nd FIG. 1 in Japanese Unexamined Patent Appl. Pub. H4-133667A.

A problem with the voltage amplitude control drive method taught in Japanese Unexamined Patent Appl. Pub. H4-222476A is that the transistors tend to heat and circuit efficiency drops because the voltage is directly controlled.

Furthermore, with the PWM drive method taught in Japanese Unexamined Patent Appl. Pub. H4-133667A, a reference pulse signal with a frequency sufficiently higher than the drive pulse signal is required to vary the pulse width of the drive pulse signal applied to the piezoelectric actuator. This results in an increase in current consumption and increases the complexity of the circuit design. More particularly, the drive circuit of small piezoelectric actuators that operate at an extremely high frequency are susceptible to shoot-through current and a drop in switching efficiency.

These drive methods therefore cannot easily freely control the current and drive output using a simple circuit arrangement.

Piezoelectric actuators normally operate using the resonance frequency, and it is extremely difficult to control the drive frequency at or within an extremely narrow range (such as within 1 kHz) near the resonance frequency.

The change in phase difference, rotor speed (amount driven), and current when sweeping the drive frequency are shown in the graph in FIG. 25. As will be known from the relationship between the drive frequency, current, and rotor speed (drive) shown in this graph, it is very difficult to control the rotor speed and control the piezoelectric actuator current by controlling the drive frequency, and the circuit design that is needed to control the rotor speed and piezoelectric actuator current by controlling the drive frequency is unavoidably complex.

The change in rotor speed and current when sweeping the pulse width of the drive signal (that is, sweeping the duty ratio) using PWM control is shown in FIG. 26. That drive control is not simple will also be understood from the relationship between the drive signal pulse width, current, and rotor speed (rotor drive) shown in FIG. 26. This is because varying the drive signal pulse width changes the drive frequency, and thus has substantially the same effect as directly controlling the drive frequency as shown in FIG. 25, and controlling the rotor speed and piezoelectric actuator current by controlling the pulse width is also difficult. Furthermore, even if such control is achieved, the circuit design of the drive control device will be complex.

A piezoelectric actuator drive control device, an electronic device, and a piezoelectric actuator drive control method according to the present invention simplify the circuit arrangement used for drive control and enable easily controlling driving a driven body and the piezoelectric actuator current.

### SUMMARY

A drive control device for a piezoelectric actuator according to the present invention is a drive control device for a piezoelectric actuator that has an oscillator that has a piezoelectric element and vibrates by supplying a drive pulse signal to the piezoelectric element, and transfers vibration of the oscillator to a driven body. The drive control device comprises a pulse width selection means for selectively switching the pulse width of a substantially constant frequency drive pulse signal between a plurality of predetermined pulse width settings. The plural pulse width settings include a first pulse width for setting the driven body or piezoelectric actuator to a first drive state, and a second pulse width for setting the driven body or piezoelectric actuator to a second drive state that is different from the first drive state, and the pulse width selection means can vary the ratio between a first pulse width selection period in which the first pulse width is selected and a second pulse width selection period in which the second pulse width is selected in a specified period.

This aspect of the invention predefines a first pulse width and a second pulse width for setting the driven body or piezoelectric actuator to a first drive state or second drive state, and can vary the ratio between the first pulse width selection period in which the first pulse width is selected and the second pulse width selection period in which the second pulse width is selected in a specified period. This ratio is also referred to below as the ratio between the periods in which the pulse width settings are selected. This aspect of the invention simplifies the circuit arrangement of the drive control device by providing a pulse width selection means. This simple circuit arrangement can freely control the piezoelectric actuator current and driving the driven body.

More specifically, the period that voltage is applied is determined by the predetermined pulse width of the drive signal, and the period that voltage is applied controls the current supply to the piezoelectric actuator and driving the driven body. Unlike PWM drive methods, the present invention does not directly control the pulse width of the drive signal and instead varies the ratio of the periods in which plural pulse widths are selected. The piezoelectric actuator current and the drive state of the driven body determined by the pulse width can therefore be stabilized and the desired drive state can be maintained.

Furthermore, unlike PWM drive methods that use a D class amplifier, this embodiment of the invention does not require a reference signal that has a higher frequency than the drive pulse signal I to vary the pulse width. Current consumption can therefore be reduced, device design can be simplified, and the circuit arrangement can be simplified.

Circuit efficiency also does not drop because the present invention does not directly control the voltage.

Furthermore, because the present invention changes the ratio of the periods in which the set pulse widths are selected, and does not directly control the pulse width or frequency of the drive pulse signal, such difficulties as limiting the pulse widths and frequencies suitable for driving are eliminated. The method of the present invention achieves a more substantially linear relationship between the control level (the ratio between the first pulse width selection period and second pulse width selection period) and current or speed than methods that vary the drive signal pulse duty (FIG. 26), and therefore affords extremely simple drive control.

A drive control method for a piezoelectric actuator according to another aspect of the invention is a drive control method for a piezoelectric actuator that comprises an oscillator that has a piezoelectric element and vibrates by supplying a drive pulse signal to the piezoelectric element, and transfers vibration of the oscillator to a driven body. The drive control method comprising steps of: selectively switching the pulse width of a substantially constant frequency drive pulse signal between a plurality of predetermined pulse width settings, wherein the plural pulse width settings include a first pulse width for setting the driven body or piezoelectric actuator to a first drive state, and a second pulse width for setting the driven body or piezoelectric actuator to a second drive state that is different from the first drive state; and varying the ratio between a first pulse width selection period in which the first pulse width is selected and a second pulse width selection period in which the second pulse width is selected in a specified period.

Similarly to the drive control device described above, the drive control method according to this aspect of the invention can vary the ratio between the pulse width selection periods, and can therefore easily and freely control driving a driven body and piezoelectric actuator current using a very simple control circuit arrangement.

As also described above, this aspect of the invention affords a circuit with low current consumption, simplifies circuit design, and does not reduce circuit efficiency.

Preferably in this piezoelectric actuator drive control device, the plural pulse width settings include a third pulse width for setting the driven body or piezoelectric actuator to a third drive state that is different from the first drive state and the second drive state; the pulse width selection means switches between the first pulse width and the third pulse width in a specified period, and between the second pulse width and third pulse width in a specified period; and the ratio in the specified period between the first pulse width selection period and a third pulse width selection period in which the third pulse width is selected, and the ratio in the specified period between the second pulse width selection period and the third pulse width selection period, are variable.

Preferably in this piezoelectric actuator drive control method, the plural pulse width settings include a third pulse width for setting the driven body or piezoelectric actuator to a third drive state that is different from the first drive state and the second drive state; the pulse width selection means switches between the first pulse width and the third pulse width in a specified period, and between the second pulse width and third pulse width in a specified period; and the ratio in the specified period between the first pulse width selection period and a third pulse width selection period in which the third pulse width is selected, and the ratio in the specified period between the second pulse width selection period and the third pulse width selection period in which the third pulse width is selected, are variable.

By changing the drive pulse signal between three frequencies, and varying the ratio between the first pulse width selection period and the third pulse width selection period, and the ratio between the third pulse width selection period and the second pulse width selection period, resolution can be improved. This affords an even more linear drive characteristic, and enables more appropriate drive control.

Further preferably, the piezoelectric actuator drive control device also has a control signal source for inputting a control signal to the pulse width selection means. The control signal is generated at one of a plurality of voltage levels, and the pulse width setting is selected according to the control signal voltage.

In a piezoelectric actuator drive control method according to another aspect of the invention, the control signal is generated at one of a plurality of voltage levels, and the pulse width setting is selected according to the control signal voltage.

These aspects of the invention output a pulse signal with high and low voltage levels as the control signal, and vary the ratio between the first pulse width selection period and second pulse width selection period of the drive pulse signal in a specified period by varying the pulse width of this control signal. The control circuit arrangement is thus simplified, and current consumption can be reduced.

If the plural voltage levels include a high impedance state in addition to the low voltage and high voltage levels, three states can be imparted to a single signal output.

A piezoelectric actuator drive control device according to another aspect of the invention additionally comprises a first switching means connected between one terminal of the piezoelectric element and a high voltage unit; a second switching means connected between the other terminal of the piezoelectric element and the high voltage unit; a third switching means connected between the other terminal of the piezoelectric element and a low voltage unit; a fourth switching means connected between the one terminal of the piezoelectric element and the low voltage unit; and a gate driver for controlling the first to fourth switching means. The gate driver applies an alternating drive voltage to the piezoelectric element by switching between a state applying a charge of a first direction to the piezoelectric element by turning the first and fourth switching means on and the second and third switching means off, and a state applying a charge of a second direction opposite the first direction to the piezoelectric element by turning the first and fourth switching means off and the second and third switching means on. The pulse width selection means generates dead time that is inserted to the drive pulse signal period, and can vary the dead time so that the drive pulse signal is output at the set pulse width, in order to suppress shoot-through current resulting from the first switching means and fourth switching means being simultaneously conductive to one terminal of the piezoelectric element, and to suppress shoot-through current resulting from the second switching means and third switching means being simultaneously conductive to the other terminal of the piezoelectric element.

A drive control method for a piezoelectric actuator according to another aspect of the invention comprising a first switching means connected between one terminal of the piezoelectric element and a high voltage unit; a second switching means connected between the other terminal of the piezoelectric element and the high voltage unit; a third switching means connected between the other terminal of the piezoelectric element and a low voltage unit; a fourth switching means connected between the one terminal of the piezoelectric element and the low voltage unit; and a gate driver for controlling the first to fourth switching means. The gate driver applies an alternating drive voltage to the piezoelectric element by switching between a state applying a charge of a first direction to the piezoelectric element by turning the first and fourth switching means on and the second and third switching means off, and a state applying a charge of a second direction opposite the first direction to the piezoelectric element by turning the first and fourth switching means off and the second and third switching means on. The drive control method further comprises a step of varying the dead time so that the drive pulse signal is output at the set pulse width when generating dead time that is inserted to the drive pulse signal period in order to suppress shoot-through current resulting from the first switching means and fourth switching means being simultaneously conductive to one terminal of the piezoelectric element, and suppress shoot-through current resulting from the second switching means and third switching means being simultaneously conductive to the other terminal of the piezoelectric element.

This embodiment of the invention enables adjusting the pulse width of the drive pulse signal by adjusting the length of the dead time, and therefore does not require a separate arrangement for varying the pulse width.

Yet further preferably, the oscillator excites an elliptical vibration by combining two vibration modes; and the drive signal is single phase.

An elliptical vibration can be excited in part of the oscillator by supplying a drive signal of a frequency between the resonance point of longitudinal vibration expanding and contracting lengthwise to the oscillator and the resonance point of sinusoidal vibration in the same lengthwise direction to a flat, substantially rectangular oscillator.

This aspect of the invention enables driving a rotor or other driven body with high efficiency by means of the elliptical vibration produced by a single phase drive signal, and enables simplifying the circuitry of the drive control device compared with arrangements that use a plurality of drive signals of different phases.

An electronic device according to another aspect of the invention comprises a piezoelectric actuator; a driven body driven by the piezoelectric actuator; and the piezoelectric actuator drive control device described above.

By comprising the piezoelectric actuator drive control device described above, an electronic device according to this aspect of the invention affords the same operation and effect as the drive control device. More specifically, by using the drive control device of a simple circuit arrangement described above, speed (torque) can be freely controlled, the response and precision of the mechanical operation can be improved, and operating noise can be reduced.

Examples of an electronic device according to the present invention include cell phones, notebook computers and personal computers, mobile toys, personal digital assistant devices (PDA), and cameras.

The electronic device according to another aspect of the invention is preferably a timepiece comprising a timekeeping unit, and a time information display unit for displaying the time information kept by the timekeeping unit.

The piezoelectric actuator can drive the gears and other parts of the timekeeping unit and time information display unit in this aspect of the invention. Displaying the hour, minute, and second by means of gears driven by the piezoelectric actuator described above enables precisely controlling the drive state of the driven body and thus affords a precision movement.

The piezoelectric actuator can also be used to drive and control a timekeeping unit and time information display unit for calendar information such as the date, month, and weekday, and is not limited to displaying the time.

The advantages of a piezoelectric actuator can also be achieved, including resistance to magnetic effects, high response with precise drive control, a small, thin footprint, and high torque output.

The piezoelectric actuator drive control device of this invention can be achieved as a hardware device or by using a software control program.

This control program can simply cause a computer incorporated in the drive control device to function as the pulse width selection means.

This aspect of the invention affords the same operation and effects as the drive control device described above, simplifies the program, and enables easily controlling driving the driven body and current flow to the piezoelectric actuator.

This control program can be written to the computer over a network, or by means of a computer-readable data storage medium to which the program is written.

The desired control program can also be incorporated when the product is shipped from the factory or as selected by the user after purchase because the functions of the various aspects of the invention can be rendered by simply writing the control program distributed by such a data storage medium or communication means such as the Internet to the timepiece or portable device. This also affords greater use of common parts in different products, and greatly reduces the cost of manufacturing a wide range of products, because timepieces and portable devices having different control methods can be manufactured by simply changing the control program.

The present invention enables easily controlling the drive state of a driven body and current flow to a piezoelectric actuator by means of a simple arrangement enabling changing the ratio between periods particular pulse width settings are selected in a specified period.

The circuit arrangement can therefore be simplified and current consumption can be reduced without lowering circuit efficiency.

### BRIEF DESCRIPTION OF THE DRAWINGS

FIG. 1 shows a timepiece according to a first embodiment of the invention.

FIG. 2 is an oblique view of the piezoelectric actuator unit in the first embodiment of the invention.

FIG. 3 is a plan view of the piezoelectric actuator unit in the first embodiment of the invention.

FIG. 4 is a block diagram of the drive control device of the piezoelectric actuator in the first embodiment of the invention.

FIG. 5A is a graph showing the relationship between drive frequency and impedance, and FIG. 5B is a graph showing the relationship between the drive frequency and the amplitude of longitudinal vibration and sinusoidal vibration in an oscillator in the first embodiment of the invention.

FIG. 6 is a timing chart for the drive control device in the first embodiment of the invention.

FIG. 7 is a waveform diagram of the drive pulse signal in the first embodiment of the invention.

FIG. 8 is a graph showing the relationship between the drive pulse signal duty ratio, rotor speed, and current flow to the piezoelectric elements in the first embodiment of the invention.

FIG. 9 is a block diagram of a piezoelectric actuator drive control device according to a second embodiment of the invention.

FIG. 10 is a timing chart for the drive control device in the second embodiment of the invention.

FIG. 11 is a block diagram of a piezoelectric actuator drive control device according to a third embodiment of the invention.

FIG. 12 is a block diagram of a piezoelectric actuator drive control device according to a fourth embodiment of the invention.

FIG. 13 is a block diagram of a piezoelectric actuator drive control device according to a fifth embodiment of the invention.

FIG. 14 is a block diagram of a piezoelectric actuator drive control device according to a sixth embodiment of the invention.

FIG. 15 is a schematic diagram of a printer according to a seventh embodiment of the invention.

FIG. 16 is a block diagram of the drive control device in the seventh embodiment of the invention.

FIG. 17 is a timing chart showing the output of the position control device and the rotor position in the seventh embodiment of the invention.

FIG. 18 is a schematic diagram of a printer according to a first variation of the invention.

FIG. 19 is a schematic diagram of a printer according to a second variation of the invention.

FIG. 20 is an oblique view of the piezoelectric actuator in the second variation of the invention.

FIG. 21 is a plan view of the piezoelectric actuator in the second variation of the invention.

FIG. 22 is a block diagram of the drive control device in the second variation of the invention.

FIG. 23 is a waveform diagram showing the phase difference of the piezoelectric actuator drive signal in the second variation of the invention.

FIG. 24 is a plan view describing the operation of the piezoelectric actuator in the second variation of the invention.

FIG. 25 is a graph showing the change in phase difference, rotor speed (drive), and current during a frequency sweep of the drive signal.

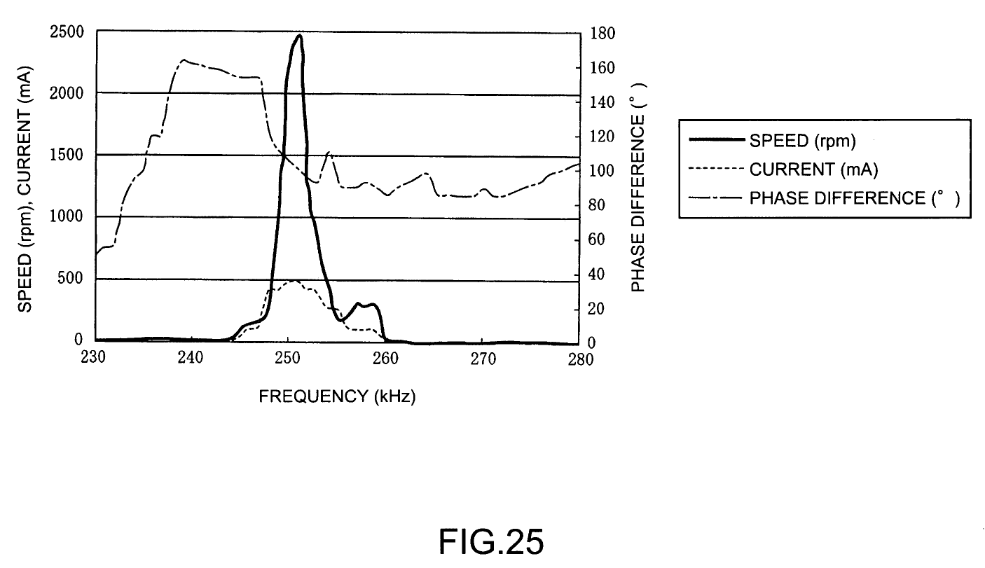

FIG. 26 is a graph showing the change in rotor speed (drive) and current during a pulse width sweep of the drive signal.

### DETAILED DESCRIPTION OF EXEMPLARY EMBODIMENTS

### First embodiment

A preferred embodiment of the present invention is described below with reference to the accompanying figures.

An electronic timepiece having a chronograph seconds hand that is driven by a piezoelectric actuator is used by way of example in this embodiment as an electronic device according to the present invention.

1. General Configuration

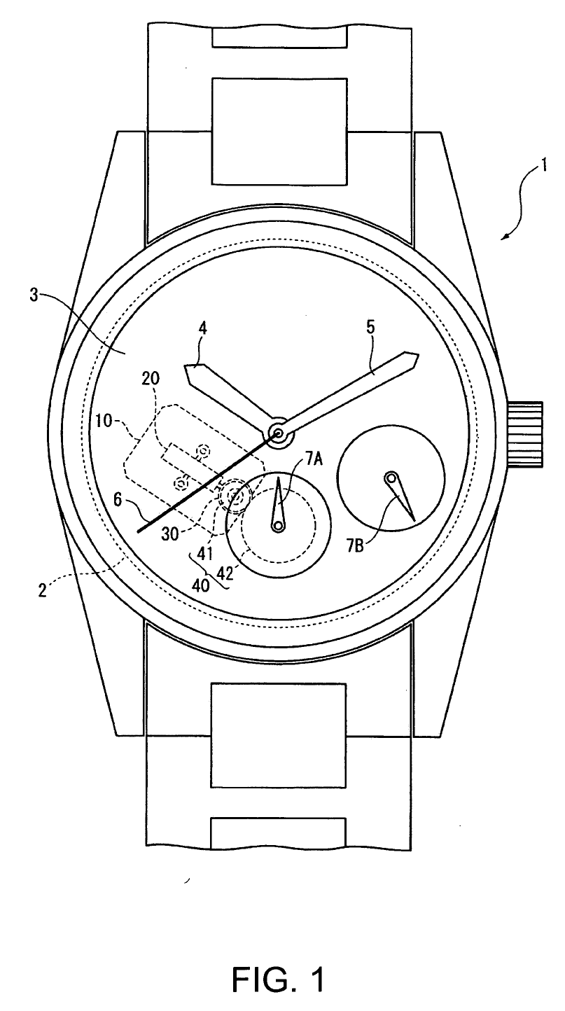

FIG. 1 is a plan view of an electronic timepiece 1 according to this embodiment of the invention. This electronic timepiece 1 has a movement 2 as the timekeeping unit, a dial 3, hour hand 4, minute hand 5, and seconds hand 6 as a time information display unit for displaying the current time, and a chronograph seconds hand 7A and chronograph minutes hand 7B for displaying the chronograph time.

The hour hand 4, minute hand 5, and seconds hand 6 are the same as in analog quartz watch, and are driven by means of a circuit board having a quartz oscillator, a stepping motor having a coil, stator, and rotor, a drive wheel chain, and a battery.

2. Chronograph Seconds Hand 7A Drive Mechanism

The drive mechanism for driving the chronograph seconds hand 7A comprises a piezoelectric actuator (ultrasonic motor) 20, a rotor 30 that is a driven body rotationally driven by the piezoelectric actuator 20, and a speed reducing gear train 40 for transferring the rotation of the rotor 30 while reducing the speed of rotation.

The speed reducing gear train 40 comprises a gear 41 that is disposed coaxially to the rotor 30 and rotates in unison with the rotor 30, and a gear 42 that meshes with gear 41 and is fixed to the rotational shaft of the chronograph seconds hand 7A.

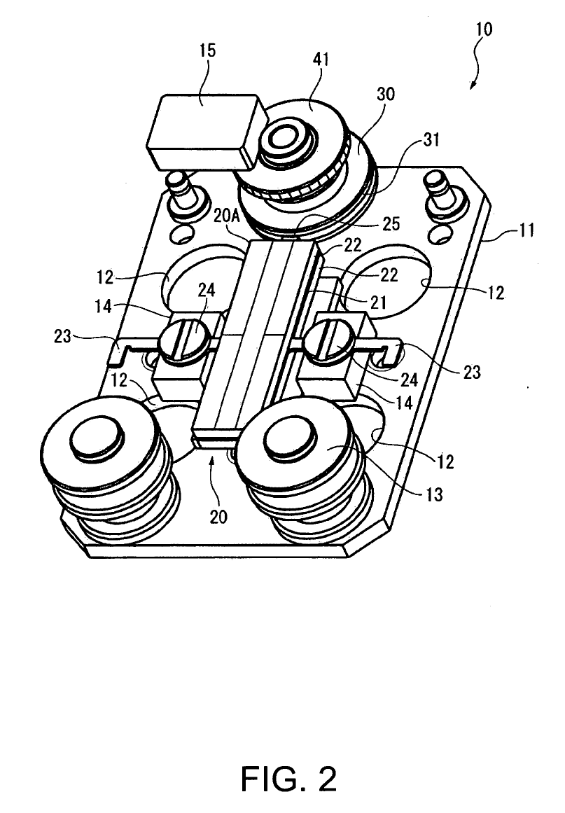

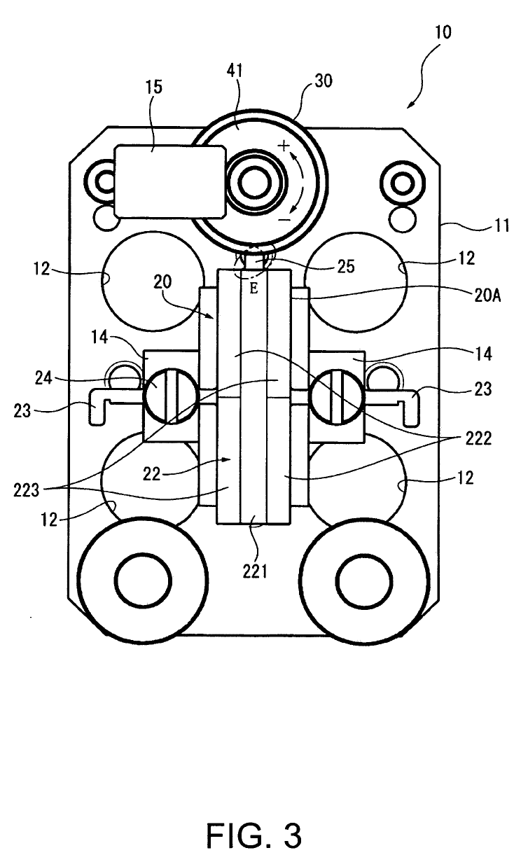

As shown in FIG. 2 and FIG. 3, the piezoelectric actuator 20, rotor 30, and gear 41 are part of a piezoelectric actuator unit 10.

3. Arrangement of the Piezoelectric Actuator Unit

The piezoelectric actuator unit 10 also comprises a support plate 11 that is fixed to the base plate of the electronic timepiece 1, for example, a piezoelectric actuator 20 fixed to the support plate 11, and a rotor 30 and gear 41 disposed to rotate freely on the support plate 11.

Gear 41 is disposed so that gear 41 rotation can be detected by a rotation sensor 15 disposed above the gear 41.

Holes 12 are rendered in the support plate 11 to reduce the weight, and the support plate 11 is secured to the base plate, for example, by screws or other fasteners 13. Spacers 14 for mounting the piezoelectric actuator 20 are also affixed to the support plate 11.

4. Arrangement of the Piezoelectric Actuator

As shown in FIG. 2 and FIG. 3, the piezoelectric actuator 20 comprises an oscillator 20A comprising a substantially rectangular, flat reinforcing plate 21 and piezoelectric elements 22 bonded to both sides of the reinforcing plate 21.

The reinforcing plate 21 has arm portions 23 extending widthwise to the reinforcing plate 21 from approximately the center of both long sides of the reinforcing plate 21, and these arm portions 23 are secured by screws 24 to the spacers 14. Note that the reinforcing plate 21 is made from an electrically conductive metal, and the arm portions 23 are used as electrodes for applying drive pulse signals to the piezoelectric elements 22.

A contact part 25 protruding in the lengthwise direction of the reinforcing plate 21 is formed on one long end of the reinforcing plate 21, specifically the end opposite the rotor 30, with the contact part 25 touching the rotor 30. The position of the contact part 25 relative to the rotor 30 is set so that the contact part 25 contacts the outside surface of the rotor 30 with a specific force, producing suitable friction between the contact part 25 and the side of the rotor 30 so that vibration of the oscillator 20A is transferred efficiently to the rotor 30.

A channel 31 (FIG. 2) is formed in the outside surface of the rotor 30, and the contact part 25 is disposed inside this channel 31 in this embodiment of the invention. This channel 31 acts as a guide to prevent the contact part 25 from separating from the contact surface of the rotor 30 in the event a shock is applied to the piezoelectric actuator 20 if the electronic timepiece 1 is dropped, for example.

The piezoelectric elements 22 are substantially rectangular, and are bonded to substantially rectangular portions on both sides of the reinforcing plate 21. Electrodes are rendered on both sides of the piezoelectric elements 22 by sputtering, vapor deposition, or other method.

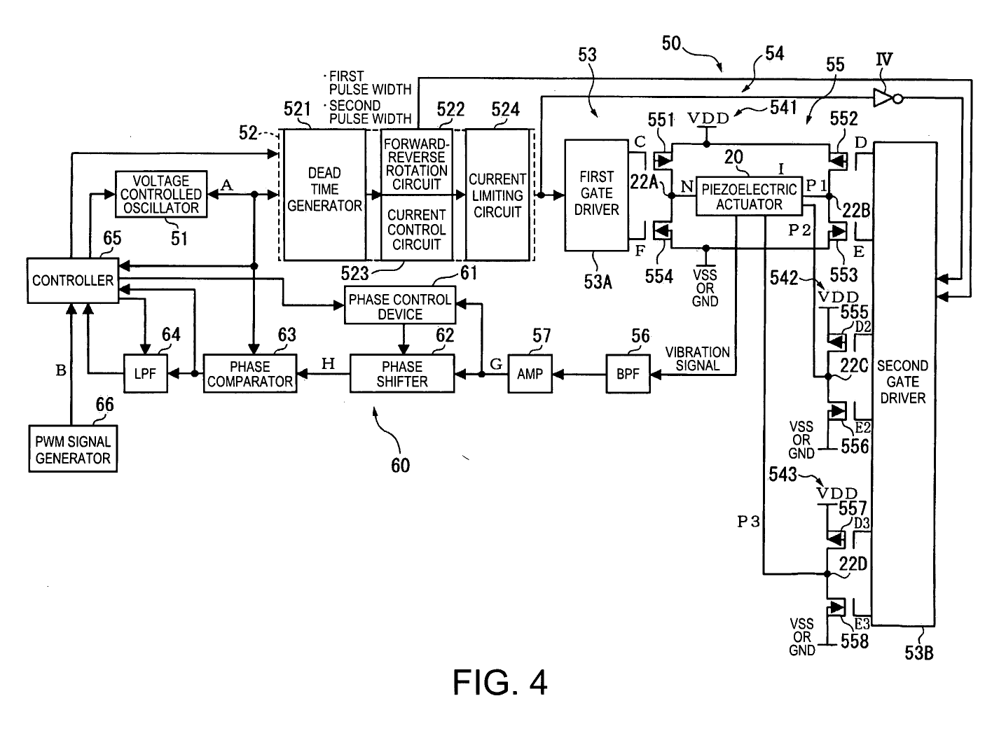

A single electrode is formed over the entire surface of the piezoelectric elements 22 facing the reinforcing plate 21, and the piezoelectric elements 22 are electrically connected to the drive control device 50 (FIG. 4) through the reinforcing plate 21 and arm portions 23 that are in contact with this electrode.

A five-segment electrode is formed on the exposed surface of the piezoelectric elements 22 as shown in FIG. 3. More specifically, the electrode on the outside surface of the piezoelectric elements 22 is divided into three equal parts across the width of the piezoelectric elements 22, and the center electrode is used as drive electrode 221. The electrodes on both sides of the drive electrode 221 are divided lengthwise to the piezoelectric elements 22 into two equal parts, and the diagonally opposite corner electrodes are paired as drive electrodes 222 and drive electrodes 223.

These drive electrodes 221, 222, and 223 are connected by leads to the drive control device 50 (lines P1 to P3 in FIG. 4), and voltage is applied between the drive electrodes and reinforcing plate 21 (see N in FIG. 4). The drive control device 50 has three power supplies, that is, to apply voltage between the drive electrode 221 and reinforcing plate 21, to apply voltage between the drive electrodes 222 and reinforcing plate 21, and to apply voltage between the drive electrodes 223 and reinforcing plate 21.

The drive control device 50 (FIG. 4) of this electronic timepiece 1 supplies a single phase drive pulse signal to the piezoelectric actuator 20 to rotationally drive the rotor 30.

Drive electrodes 222 and drive electrodes 223 disposed to the piezoelectric elements 22 are selectively used depending on whether the chronograph seconds hand 7A is driven to rotate forward or reverse, and the rotor 30 is driven rotationally in both directions according to the vibration behavior of the oscillator 20A.

More specifically, to drive the rotor 30 in the forward direction as a result of the forward vibration behavior of the oscillator 20A, voltage is applied to drive electrode 221 and drive electrodes 222. The phase difference of the resulting mixed vibration mode combining a longitudinal primary vibration and a secondary sinusoidal vibration from the expansion and contraction of the piezoelectric elements 22 causes the oscillator 20A to vibrate on an elliptical path. As a result, the contact part 25 of the oscillator 20A traces an elliptical path E (FIG. 3) biased to the lengthwise center axis of the piezoelectric elements 22. The contact part 25 strikes the rotor 30 during part of this path E, and causes the rotor 30 to rotate in a forward direction (denoted by the + sign in FIG. 3).

To drive the rotor 30 in the reverse direction as a result of the reverse vibration behavior of the oscillator 20A, voltage is applied to drive electrode 221 and drive electrodes 223 instead of drive electrodes 222. Because drive electrodes 222 and drive electrodes 223 are disposed line symmetrically to the lengthwise center axis of the piezoelectric elements 22, the path of the contact part 25 is an elliptical path that is substantially line symmetric to the path when voltage is applied to the drive electrodes 222. As a result, the rotor 30 turns in the opposite or reverse direction (denoted by a − sign in FIG. 3).

When the rotor 30 turns, the gear 41 turns in unison with the rotor 30, causing gear 42 to turn in conjunction with gear 41 rotation, and thus causing the chronograph seconds hand 7A to turn either forward or reverse.

The detection signal (vibration signal) denoting the vibration state of the oscillator 20A is detected through the drive electrodes to which the drive signal is not applied when the rotor 30 turns in a particular direction. As a result, when the rotor 30 rotates forward, the detection signal is detected through drive electrodes 223, and when the rotor 30 rotates in reverse, the detection signal is detected through drive electrodes 222.

5. Configuration of the Piezoelectric Actuator Drive Device

The configuration of the drive control device 50 of the piezoelectric actuator 20 is described next with reference to FIG.

As shown in FIG. 4, the drive control device 50 comprises a voltage controlled oscillator (VCO) 51, a pulse control circuit 52 comprising a pulse width selection means, a gate driver 53, a power supply 54, a switching circuit 55, a bandpass filter (BPF) 56, a signal amplifier (AMP) 57, a phase difference detection means 60, a controller 65, and a PWM signal generator 66 as a control signal source.

The voltage controlled oscillator 51 is an oscillator for outputting a variable frequency reference pulse signal that is used to generate the drive pulse signal according to the applied voltage. The switching circuit 55 then switches according to this reference pulse signal to generate the alternating voltage drive pulse signal that is supplied to the piezoelectric actuator 20. The frequency of the reference pulse signal and drive pulse signal is substantially constant.

The frequency (drive frequency) of the reference pulse signal and drive pulse signal is determined according to the resonance point of the longitudinal vibration and the resonance point of the sinusoidal vibration of the oscillator 20A.

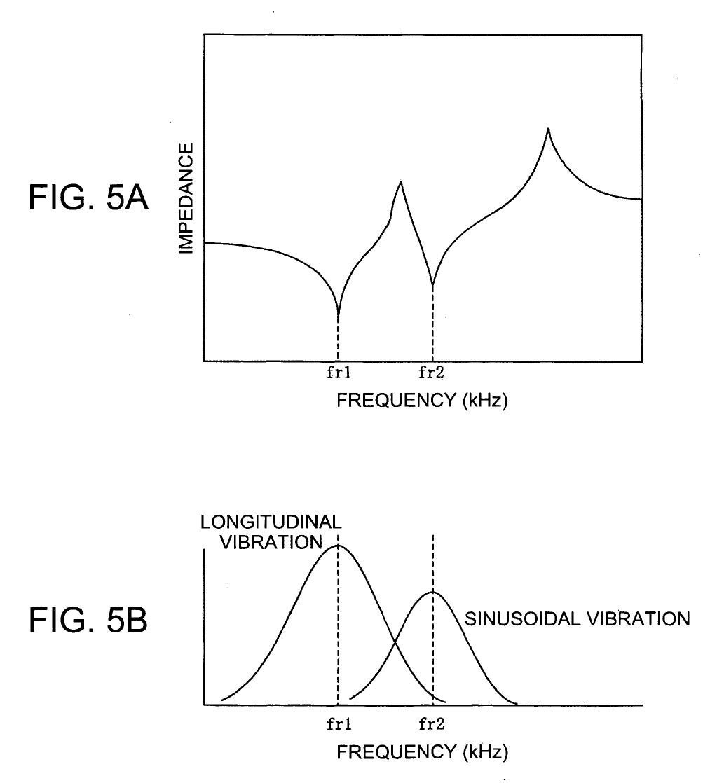

FIG. 5A shows the relationship between the drive frequency of the oscillator 20A and impedance, and FIG. 5B shows the relationship between the drive frequency of the oscillator 20A and the amplitude of the longitudinal vibration and the amplitude of the sinusoidal vibration.

As shown in FIG. 5A, there are two resonance points where impedance is lowest and amplitude is highest relative to the drive frequency. The resonance point where the frequency is lower is the resonance point of the longitudinal vibration, and the resonance point where the frequency is higher is the resonance point of the sinusoidal vibration.

More specifically, if the oscillator 20A is driven between the longitudinal resonance frequency fr1 of the longitudinal vibration and the sinusoidal resonance frequency fr2 of the sinusoidal vibration, the amplitude of both the longitudinal vibration and the sinusoidal vibration is assured and the piezoelectric actuator 20 can be driven with high efficiency. Bringing the longitudinal resonance frequency fr1 and sinusoidal resonance frequency fr2 closer together enables setting a drive frequency that results in a higher longitudinal vibration and sinusoidal vibration amplitude.

Referring again to FIG. 4, the pulse control circuit 52 is a circuit for generating dead time for the reference pulse signal, and then outputting the reference pulse signal with the dead time added. The pulse control circuit 52 comprises a dead time generator 521 for generating the dead time to control the switching timing of the switching circuit 55 described below and suppress the shoot-through current, a forward-reverse rotation circuit 522 and current control circuit 523 for changing the direction of rotor 30 rotation and outputting the appropriate control value, and a current limiting circuit 524 for inserting the dead time at the drive signal period to regulate the drive signal duty.

The forward-reverse rotation circuit 522 outputs a control value for switching the direction of rotor 30 rotation to the second gate driver 53B. More specifically, the forward-reverse rotation circuit 522 selectively outputs control values corresponding to drive electrodes 221 and 222 to the second gate driver 53B to drive the rotor 30 in the forward rotation direction, and selectively outputs control values corresponding to drive electrodes 221 and 223 to drive the rotor 30 in the reverse direction.

The pulse width of the reference pulse signal is varied as a result of inserting the dead time to a predetermined cycle of the reference pulse signal in the pulse control circuit 52, and one of plural predetermined set pulse widths, specifically either a first pulse width or a second pulse width in this embodiment, is selected as the pulse width of the reference pulse signal. The pulse width of the drive pulse signal is therefore also controlled to either this first pulse width or second pulse width.

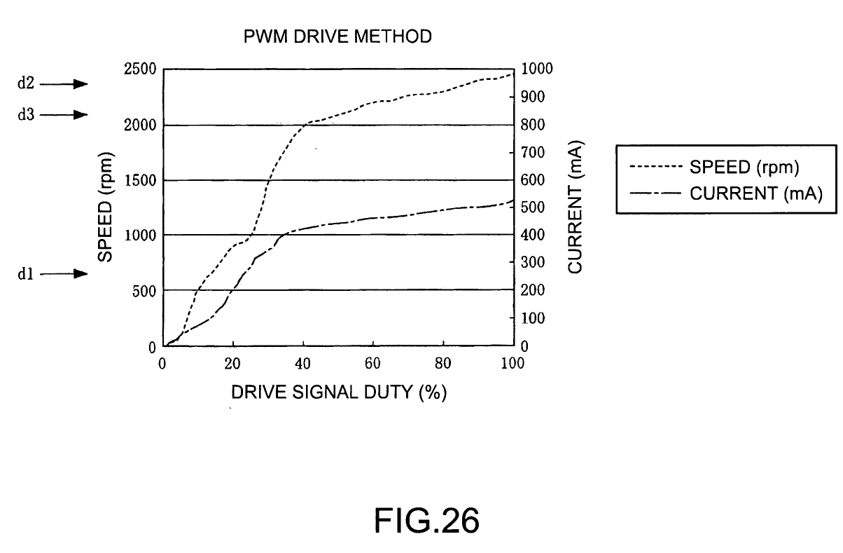

The first pulse width and second pulse width are used for setting the rotor 30 to a first drive state and second drive state, respectively, under specific drive conditions. This was previously described with reference to sweeping the pulse width of the drive pulse signal and the first drive state d1 and second drive state d2 shown in FIG. 26.

The first drive state d1 of the rotor 30 is a low speed drive state in which the rotor 30 turns at approximately 625 rpm, and the duty ratio of the first pulse width is set to 12.5% based on the pulse width of the drive signal at this time.

The second drive state d2 of the rotor 30 is a high speed drive state in which the rotor 30 turns at approximately 2400 rpm, and the duty ratio of the second pulse width is set to 95% based on the pulse width of the drive signal at this time.

This embodiment of the invention uses approximately 625 rpm and approximately 2400 rpm as the first drive state d1 and second drive state d2 of the rotor 30 because there is little variation in the rotor 30 speed and the rotation characteristic of the rotor 30 is stable at these rates, but the invention is not so limited and other rotational velocities can be selected as the first drive state d1 and second drive state d2 of the rotor 30.

Furthermore, the first and second pulse widths are set based on the speed of the rotor 30 in this embodiment of the invention, but the first drive state and second drive state can be regulated according to the current supplied to the piezoelectric actuator 20, and the pulse width of the drive signal regulating the current can be set as the first and second pulse widths.

The gate driver 53 is a means for controlling the on/off state of the switching circuit 55 based on the reference pulse signal output from the pulse control circuit 52, and in this embodiment of the invention comprises a first gate driver 53A and second gate driver 53B.

The drive signal input from the pulse control circuit 52 to the second gate driver 53B passes inverter (NOT gate) IV, and the voltage level is therefore opposite the voltage level of the drive signal input to the first gate driver 53A.

The power supply 54 in this embodiment of the invention comprises a first power supply 541 that is used when the rotor 30 rotates forward and reverse, a second power supply 542 that is used only when the rotor 30 rotates forward, and a third power supply 543 that is used only when the rotor 30 turns in reverse. These first, second, and third power supplies 541, 542, and 543 apply a voltage of the potential difference between power supply VDD and VSS, or between VDD and GND, to the piezoelectric actuator 20.

The switching circuit 55 comprises switches 551, 552, 555, 557, which are p-channel MOS-FET devices in this embodiment of the invention, and switches 553, 554, 556, 558, which are n-channel MOS-FET devices in this embodiment of the invention. These switches 551 to 558 are controlled by the voltage applied to the gate by first gate driver 53A or second gate driver 53B, and are thereby controlled to the on or off state.

The second gate driver 53B is connected to forward-reverse rotation circuit 522, and drives only switches 552, 553 (FIG. 4, P1) and switches 555, 556 (P2) when the rotor 30 rotates forward.

More specifically, when the rotor 30 turns forward, the first gate driver 53A driving switches 551 and 554, and the second gate driver 53B driving switches 552 and 553 (P1) and switches 555 and 556 (P2), output mutually inverted drive signals, thus setting switches 551 and 552, which are both p-channel MOS-FET devices, to opposite states so that when switch 551 is on, switch 552 is off. This also applies to p-channel MOS-FET switches 551 and 555.

Switches 553 and 554, which are both n-channel MOS-FET devices, behave in the same way. That is, when one switch 553 is on, the other switch 554 is off. This also applies to n-channel MOS-FET switches 556 and 554.

When one of serially connected switches 551 and 554 is on, the other is off. Likewise, when one of serially connected switches 552 and 553, or switches 555 and 556, is on, the other is off.

Switches 551 to 554 (or switches 551, 555, 556, 554) are bridge connected to the piezoelectric elements 22 by first gate driver 53A and second gate driver 53B. More specifically, switch 551 is connected between one node 22A of the piezoelectric elements 22 and VDD, switch 552 (or switch 555) is connected between the other node 22B of the piezoelectric elements 22 and VDD, switch 553 (or switch 556) is connected between the other node 22B of the piezoelectric elements 22 and VSS or GND, and switch 554 is connected between the first node 22A of piezoelectric elements 22 and VSS or GND. These bridge connected switches 551 to 554 and switches 551, 555, 556, 554 render first to fourth switching means, respectively.

The switch circuit rendered by the pair of switches 551, 553 (or switches 551, 556) at diagonally opposite parts of the bridge, and the switch circuit rendered by the pair of switches 552, 554 (or switches 555, 554) are alternately switched on/off. As a result, the specific supply voltage applied by the power supply 54 is converted to an alternating rectangular wave voltage and applied to the piezoelectric actuator 20. In other words, first power supply 541 and second power supply 542 apply an alternating voltage to the piezoelectric elements 22 between the drive electrodes 221 and 222 and reinforcing plate 21 (FIG. 2) to drive the rotor 30 in the forward rotating direction.

To drive the rotor 30 in the reverse direction, second gate driver 53B drives switches 557, 558 (P3) instead of switches 555, 556 (P2) so that switches 551, 552, 553, 554 (or switches 551, 557, 558, 554) are bridge connected to the piezoelectric elements 22. More specifically, switch 551 is connected between the one node 22A of piezoelectric elements 22 and VDD, switch 552 (or switch 557) is connected between the other node 22B of piezoelectric elements 22 and VDD, switch 553 (or switch 558) is connected between the other node 22B of piezoelectric elements 22 and VSS or GND, and switch 554 is connected between the first node 22A of piezoelectric elements 22 and VSS or GND. These bridge connected switches 551, 552, 553, 554 and switches 551, 557, 558, 554 render first to fourth switching means, respectively.

The switch circuit rendered by the pair of switches 551, 553 (or switches 551, 558) at diagonally opposite parts of the bridge, and the switch circuit rendered by the pair of switches 554, 552 (or switches 554, 557) are alternately switched on/off. In other words, first power supply 541 and third power supply 543 apply an alternating voltage to the piezoelectric elements 22 between the drive electrodes 221 and 223 and reinforcing plate 21 (FIG. 2) to drive the rotor 30 in the reverse rotating direction.

If the serially connected switches 551, 554 or switches 552, 553 (or switches 555, 556 or switches 557, 558) go on simultaneously when switching the on/off state of switches 551 to 558, shoot-through current flows. Because this shoot-through current is not used for driving the piezoelectric actuator 20, it simply wastes power and can result in burning switch devices. The pulse control circuit 52 therefore prevents shoot-through current flow by waiting a predetermined time (dead time) after turning one switch off before turning the other switch on.

The bandpass filter 56 (single peak) passes only those detection signals detected from the vibration state of the piezoelectric actuator 20 that are within a predetermined frequency band, and eliminates signals of all other frequencies.

The detection signal is detected through the drive electrodes 222 or 223 that are not used to supply the drive signal causing the rotor 30 to rotate forward or reverse (see P2 and P3 in FIG. 5). Using the potential of the arm portions 23 (N in FIG. 5) as a reference signal, the detection signal is detected from the potential difference between the reference signal and the potential of the drive electrodes 222, or the reference signal and the potential of the drive electrodes 223, that is, from a difference signal of the drive electrodes 222 or 223 to the arm portions 23. The detection signal passed by the bandpass filter 56 is amplified by the signal amplifier 57, compared with a predetermined threshold value by a comparator, digitized, and output to the phase shifter 62.

The phase difference detection means 60 comprises a phase control device 61, phase shifter 62, phase comparator 63, and lowpass filter (LPF) 64.

The phase control device 61 outputs a control signal that is set to a predetermined value based on a predetermined target phase difference to the phase shifter 62 at every second period of the detection signal. The phase shifter 62 shifts the phase of the detection signal according to this control signal.

The phase comparator 63 compares the phase of the detection signal output from the phase shifter 62 and the phase of the drive signal output from the voltage controlled oscillator 51, and outputs the phase difference to the lowpass filter 64. As noted above, the phase shifter 62 shifts the phase of the detection signal only by the targeted phase difference, and the closer the output of the phase comparator 63 is to zero, the closer the actual phase difference is to the targeted phase difference.

The lowpass filter 64 passes only signals of a frequency less than or equal to a specified frequency, and eliminates signals of a frequency greater than or equal to the specified frequency, and functions as an integration circuit.

The phase difference detection means 60 therefore outputs the difference between the phase of the drive signal and the phase of the detection signal shifted by the phase shifter 62, that is, the deviation (magnitude) to the target phase difference, through the lowpass filter 64 to the controller 65.

The controller 65 outputs a voltage signal to the voltage controlled oscillator 51 and a command value to the pulse control circuit 52 to eliminate deviation to the input target phase difference.

The PWM signal generator 66 outputs a control pulse signal controlling the drive state of the rotor 30 based on external input to the controller 65. This pulse signal is a PWM signal of variable pulse width.

This control pulse signal is output through the controller 65 to the pulse control circuit 52, and the pulse width of the reference pulse signal output by the pulse control circuit 52 is selected according to the voltage level of this control pulse signal. 6. Drive control of the piezoelectric actuator

The operation of the PWM signal generator 66 and pulse control circuit 52 that is characteristic of the drive control applied by the drive control device 50 in this embodiment of the invention is described next.

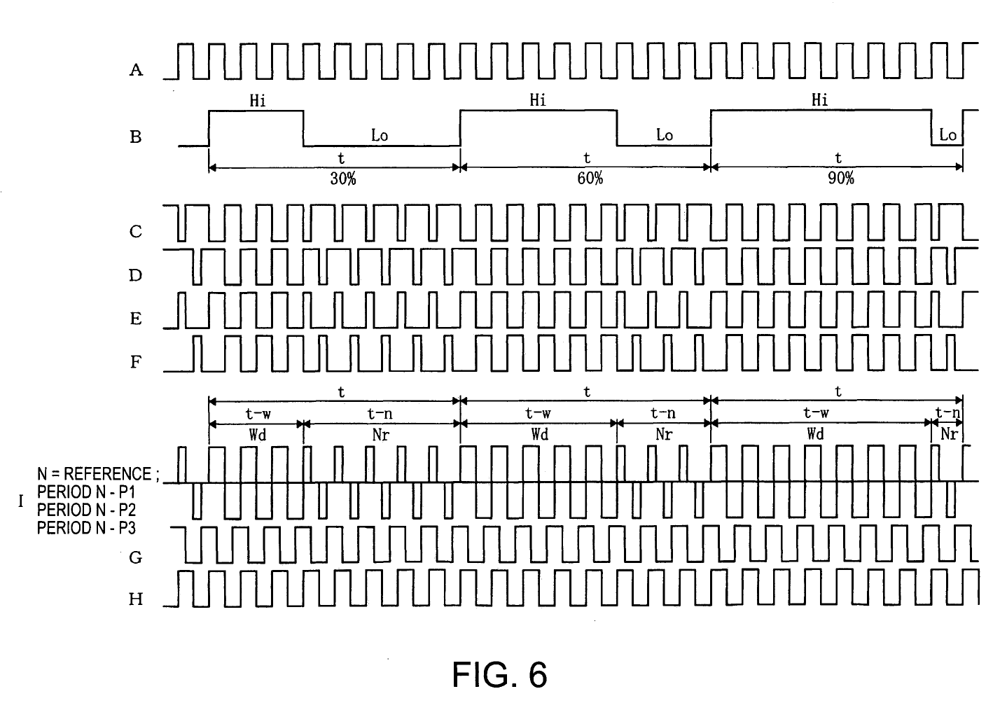

FIG. 6 shows signals A, B, C, D, E, F, G, H in FIG. 4, and can be used as a timing chart of drive control device 50 operation.

Signal A in FIG. 6 indicates the reference pulse signal output from the voltage controlled oscillator 51. The frequency of reference pulse signal A is substantially constant, and the pulse width of reference pulse signal A is substantially constant and equal to the second pulse width.

Signal B in FIG. 6 denotes the control pulse signal output from the PWM signal generator 66.

The frequency difference between reference pulse signal A and control pulse signal B is actually greater than that shown in FIG. 6, and the frequency of control pulse signal B is preferably from 1/20 to 1/100 the frequency of reference pulse signal A in order to reduce current consumption by the drive control device 50.

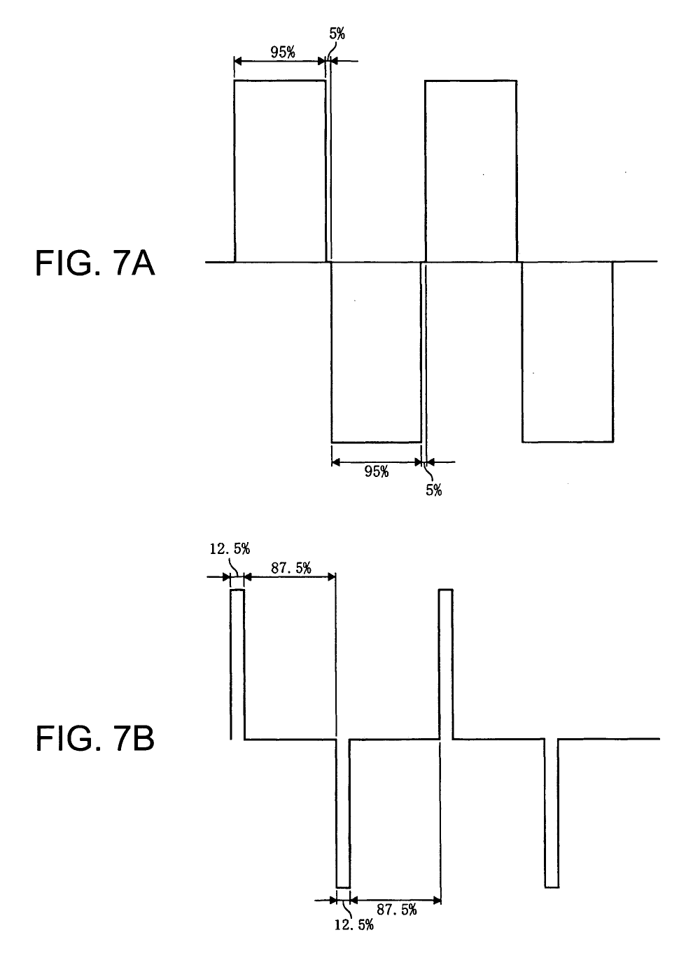

The pulse widths shown in FIG. 6 are shown schematically for reference only, and the actual waveform of the drive pulse signal I is shown in FIG. 7.

The reference pulse signal A is input to the pulse control circuit 52, the pulse control circuit 52 adjusts the pulse width, and the switches 551 to 558 are switched on/off as indicated by signals C to F in FIG. 6. More specifically, switches at diagonally opposite parts of the bridge (C and E in FIG. 4 (where E2 and E3 are the same as E) or F and D (where D2 and D3 are the same as D)) switch on/off at the same time, and by alternately switching these switches on/off, drive pulse signals I with alternating voltage are supplied to the piezoelectric actuator 20, causing the oscillator 20A to vibrate due to expansion/contraction of the piezoelectric elements 22.

Signal G in FIG. 6 denotes the detection signal (vibration signal) input to the phase shifter 62, and signal H denotes the output of phase shifter 62.

6-1. Selecting the Pulse Width of the Drive Pulse Signal

The reference pulse signal A output from the voltage controlled oscillator 51 is input to the pulse control circuit 52. The pulse control circuit 52 selects either the first pulse width or second pulse width according to the voltage of the control pulse signal B input from the PWM signal generator 66 through the controller 65 to the pulse control circuit 52, and switches the pulse width of the reference pulse signal A to the selected first or second pulse width. The pulse width of the drive pulse signal I is also selectively switched to either the first or second pulse width at the same time.

More specifically, as shown in FIG. 6, if the control pulse signal B is Lo (the voltage is low), the first pulse width (Nr (Narrow)) is selected, and if the control pulse signal B is Hi (voltage is high), the second pulse width (Wd (Wide)) is selected.

When the pulse width of the drive pulse signal I is the second pulse width (Wd), the pulse width of the drive pulse signal I is wide, the period voltage is applied is long, rotor 30 torque resulting from pressure applied by the piezoelectric elements 22 is high, and the rotor 30 turns at high speed.

However, when the pulse width of the drive pulse signal I is the first pulse width (Nr), the pulse width of the drive pulse signal I is short, the period voltage is applied is short, rotor 30 torque resulting from pressure applied by the piezoelectric elements 22 is low, and the rotor 30 turns at low speed due to friction with the oscillator 20A.

Switching the pulse width is controlled according to the dead time of the reference pulse signal A inserted by the pulse control circuit 52. The dead time when the second pulse width (Wd) is selected is not shown in FIG. 6, but the dead time inserted to the reference pulse signal A by the pulse control circuit 52 is denoted by the duty ratio of the drive pulse signal I shown in FIG. 7.

FIG. 7A shows the drive pulse signal I when the second pulse width (Wd) is selected, and FIG. 7B shows the drive pulse signal I when the first pulse width (Nr) is selected.

As shown in FIG. 7A, when the second pulse width (Wd) is selected, the duty ratio of the drive pulse signal I is 95%, and the period equal to the 5% when voltage is not applied is the dead time inserted by the pulse control circuit 52 to the reference pulse signal A period.

As shown in FIG. 7B, when the first pulse width (Nr) is selected, the duty ratio of the drive pulse signal I is 12.5%, and the period equal to the 87.5% when voltage is not applied is the dead time inserted by the pulse control circuit 52 to the reference pulse signal A period. The first pulse width (Nr) is thus set so that when the first pulse width (Nr) is selected the non-conducting time of the switches 551 to 558 is increased by setting the dead time longer than the time required to prevent shoot-through current.

6-2. Ratio Between the Pulse Width Selection Periods

Varying the ratio between the first pulse width and second pulse width selection times in the drive pulse signal I is described next.

Because the pulse width of the control pulse signal B is variable, the duty ratio determined by the pulse width (the Hi portion) changes as shown in FIG. 6 between 30%, 60%, and 90%.

Because the Hi/Lo state of the control pulse signal B corresponds to the second pulse width (Wd) and first pulse width (Nr) of the drive pulse signal I, the ratio between the period t-w when the second pulse width (Wd) is selected as the pulse width of the drive pulse signal I and the period t-n when the first pulse width (Nr) is selected in a constant period t varies in conjunction with change in the duty ratio of the control pulse signal B.

The ratio between the period when the rotor 30 is driven in the first drive state d1 (low speed rotation) and the period when driven in the second drive state d2 (high speed rotation) therefore changes, and the rotor 30 is driven evenly in the first drive state d1 and second drive state d2.

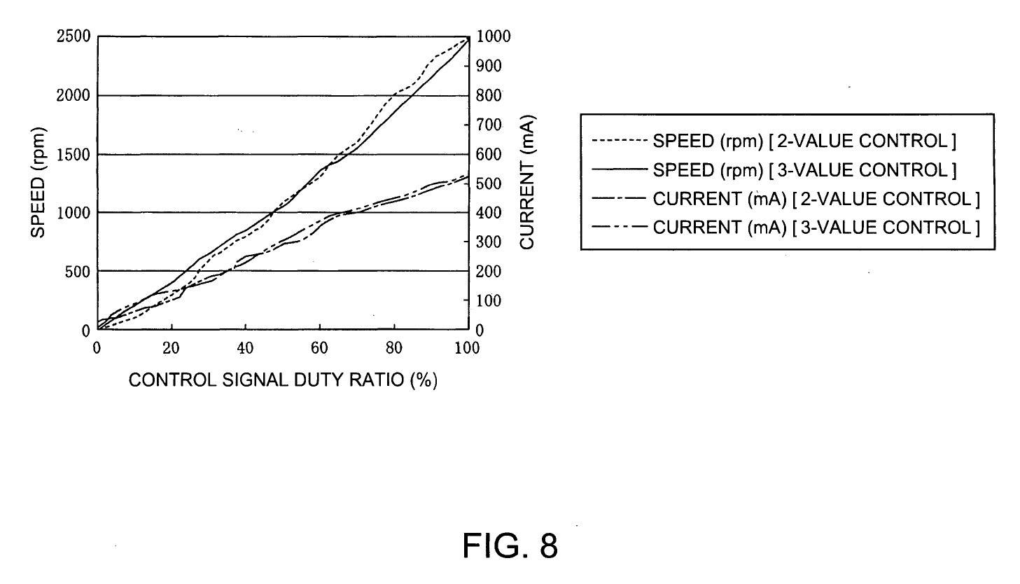

FIG. 8 is a graph showing the relationship between the duty ratio of the control pulse signal B, rotor 30 speed, and current flow to the piezoelectric actuator 20.

As will be known from this graph, the speed of the rotor 30 and the current flow to the piezoelectric actuator 20 vary substantially linearly to the duty ratio of the control pulse signal B, and the duty ratio of the control pulse signal B can be easily determined.

More specifically, while the relationship between rotor speed, current, and the pulse width of the drive pulse signal is not linear when the pulse width of the drive signal is swept in a PWM control method (FIG. 26), the method of the present invention enables easily controlling the rotor 30 speed and piezoelectric actuator 20 current. More particularly, the speed of the rotor 30 (and the piezoelectric actuator 20 current) can be freely controlled by desirably setting the duty ratio of the control pulse signal B between 0 and 100.

7. Effect of this Embodiment

This embodiment of the invention has the following effects.

(1) A first pulse width (Nr) and second pulse width (Wd) for setting the rotor 30 to a first drive state d1 and second drive state d2 are preset in the drive control device 50 that drives the piezoelectric actuator 20, and the ratio between the periods t-n and t-w the first pulse width (Nr) and second pulse width (Wd) are selected in a specific period t is variable. The drive control device 50 in this embodiment of the invention has a pulse width dead time generator (pulse width selection means) 52 to simplify the control circuit arrangement. This simple arrangement enables freely controlling driving the rotor 30. As a result, the response and precision of the operation of the chronograph seconds hand 7A that is driven by the piezoelectric actuator 20 can be improved.

Because the second pulse width (Wd) is set near the maximum rotor 30 speed, the ratio of the second pulse width (Wd) selection period t-w to the specific period t is increased and the rotor 30 can be driven highly efficiently.

(2) The drive control device 50 simply enables changing the ratio of the periods t-n and t-w that specific pulse width settings are selected, and does not directly control the pulse width or the frequency of the drive pulse signal I. Difficulties limiting the pulse width or frequency suitable for drive control are thus eliminated. More specifically, a substantially linear drive characteristic can be achieved and drive control can be simplified by changing the ratio of period t-n and period t-w in constant period t.

Furthermore, unlike PWM drive methods that use a D class amplifier, this embodiment of the invention does not require a reference signal that has a higher frequency than the drive pulse signal I to vary the pulse width. Current consumption can therefore be reduced, device design can be simplified, and the circuit arrangement can be simplified.

Circuit efficiency also does not drop because the present invention does not directly control the voltage.

(3) Furthermore, the circuit arrangement of the drive control device 50 is simplified and low current consumption is afforded by enabling changing the period t-n when the first pulse width (Nr) is selected and the period t-w when the second pulse width (Wd) is selected in constant period t by simply changing the pulse width of the control pulse signal B.

(4) Furthermore, the drive control device 50 can control the piezoelectric actuator 20 current and rotor 30 drive as desired as a result of the phase difference feedback control provided by the phase shifter 62 and phase comparator 63, for example.

(5) The amplitude of the longitudinal vibration and sinusoidal vibration can be increased and drive efficiency can be improved because the drive frequency of the oscillator 20A is between the resonance frequency of the longitudinal vibration and the resonance frequency of the sinusoidal vibration.

In addition, the effect of controlling the piezoelectric actuator 20 by means of the drive control device 50 described in this embodiment of the invention is great because the drive frequency range is narrow and controlling the drive frequency is difficult when using resonance as described above.

Furthermore, the drive control device 50 can also be widely used as a drive control device for any piezoelectric actuator that uses resonance, and is not limited to controlling piezoelectric actuator 20.

(6) The drive means of the hour hand 4, minute hand 5, and seconds hand 6 in an electronic timepiece 1 is generally a stepping motor. This stepping motor can be replaced by a piezoelectric actuator 20, however, to further reduce the thickness of the electronic timepiece 1 and improve the magnetic resistance of the electronic timepiece 1 because a piezoelectric actuator 20 is less susceptible to magnetic interference than a stepping motor.

### Second Embodiment

A second embodiment of the invention is described next below.

Note that like parts in this and the first embodiment are identified by the same reference numerals, and further description thereof is omitted.

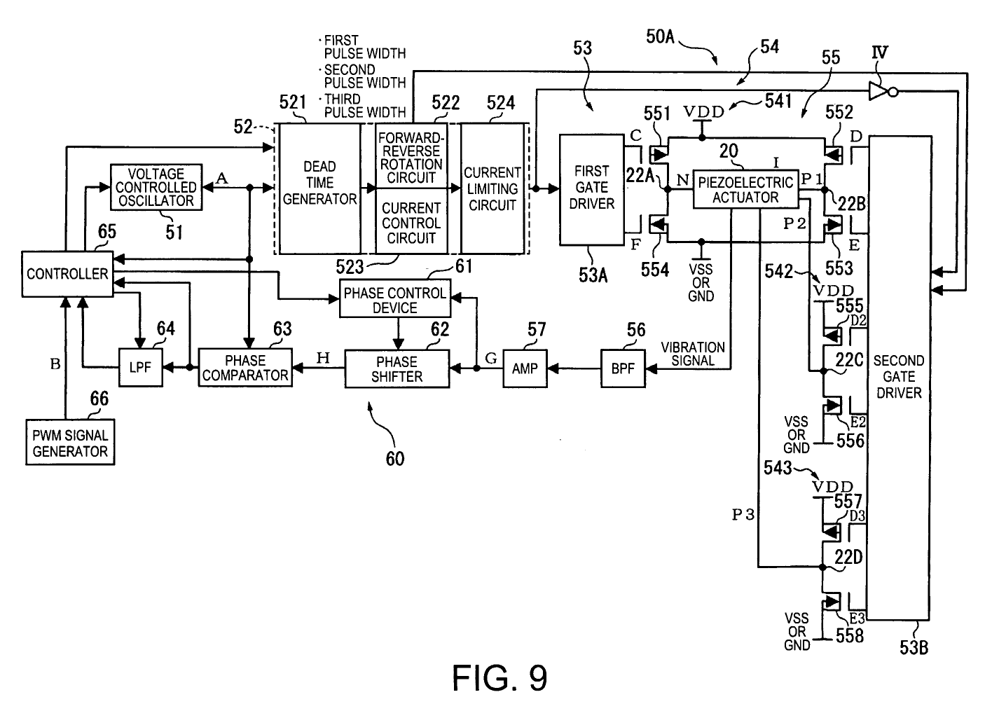

FIG. 9 is a block diagram of a piezoelectric actuator 20 drive control device 50A according to this embodiment of the invention.

The drive control device 50 in the first embodiment of the invention selects a first pulse width or second pulse width as the pulse width of the drive pulse signal. The drive control device 50A in this second embodiment of the invention differs in that the drive pulse signal is a three-value signal, and the pulse width of the drive pulse signal can be set to a first pulse width, second pulse width, or third pulse width.

The pulse control circuit 52 stores three pulse width settings, specifically the first pulse width and second pulse width described above and a third pulse width approximately midway between the first pulse width and second pulse width, and outputs the reference pulse signal at one of these pulse widths.

More specifically, the first pulse width and second pulse width are set to a duty ratio of 12.5% and 95%, respectively, as in the first embodiment, and the third pulse width is set to a duty ratio of 50%.

The first pulse width sets a first drive state d1 for driving the rotor 30 at low speed and the second pulse width sets the second drive state d2 for driving the rotor 30 at high speed as shown in FIG. 26, and the third pulse width sets a third drive state d3 for driving the rotor 30 at a moderately high speed of approximately 2100 rpm.

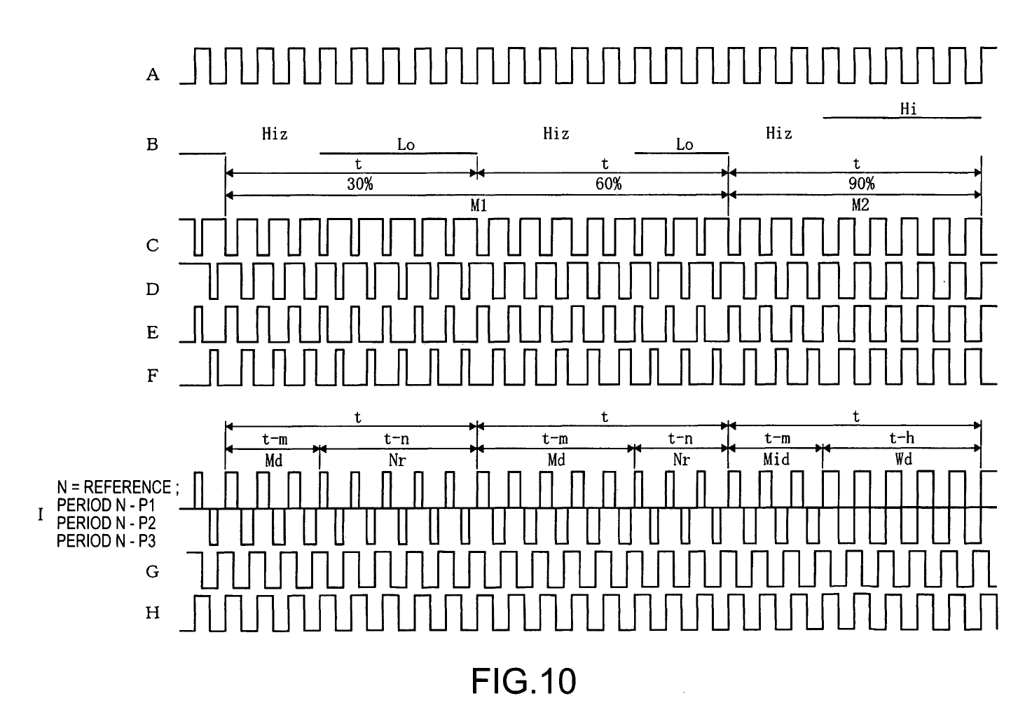

FIG. 10 is a timing chart of drive control by this drive control device 50A.

In this embodiment of the invention the control signal B output by the PWM signal generator 66 has three states: Hi (high voltage), Lo (low voltage), and high impedance (Hiz). The first pulse width (Nr) (Narrow) is selected as the pulse width of the drive pulse signal I when the control signal B is Lo, the third pulse width (Md) (Medium) is selected when the control signal is Hiz, and the second pulse width (Wd) (Wide) is selected when the control signal B is Hi.

The control signal B can switch between Lo and Hiz, and between Hiz and Hi.

The PWM signal generator 66 has two operating modes, a first mode M1 for switching the state of the control signal B to Lo and Hiz, and a second mode M2 for switching the state of the control signal B to Hi and Hiz. The PWM signal generator 66 is set to mode M1 or mode M2 by an external input signal.

Operation of the drive control device 50A according to this embodiment of the invention is described next.

In FIG. 10 the PWM signal generator 66 is initially set to the first mode M1 and the control signal B switches between Lo and Hiz. If the ratio of the Hiz period to the specified period t (Lo+Hiz) in control signal B is 50% or more, the PWM signal generator 66 switches to the second mode M2 and control signal B switches between Hiz and Hi. What is shown as 30% in the figure in the second mode M2 is the ratio of the Hi period in specified period t (Hiz+Hi). 101841 By thus switching the control signal B, the ratio of the periods t-n and t-m when first pulse width (Nr) and third pulse width (Md), respectively, are selected as the pulse width of the drive pulse signal I can be changed when the control signal B is set to the first mode M1.

In addition, the ratio of the periods t-m and t-w when the third pulse width (Md) and second pulse width (Wd), respectively, are selected as the pulse width of the drive pulse signal I can be changed when the control signal B is set to the second mode M2.

The relationship between the duty ratio of the control signal B (the ratio of the Hiz period to the specified period t, and the ratio of the Hi period to the specified period t, in modes M1 and M2, respectively), the speed of the rotor 30, and the current flow to the piezoelectric elements 22 in this embodiment of the invention is as shown in FIG. 8. When the rotor 30 speed and current flow to the piezoelectric actuator 20 vary substantially linearly to the duty ratio of the control signal B, and three-value control using first to third pulse widths is applied as described in this embodiment of the invention, a more linear drive characteristic can be achieved than is possible with two-value control using first and second pulse widths as in the first embodiment of the invention.

In addition to the effects of the first embodiment described above, this embodiment of the invention affords the following effects.

(7) By changing the pulse width of the drive pulse signal I between first, second, and third pulse widths, and switching the control signal B, resolution can be increased by changing the ratio between the first pulse width selection period t-m and the third pulse width selection period t-m, and the ratio between the third pulse width selection period t-m and the second pulse width selection period t-w. This affords an even more linear drive characteristic, and enables more appropriate drive control.

(8) Three different states can be imparted to one signal output as a result of using three states, that is, low voltage, high voltage, and high impedance, as the signal states of the control signal B.

### Third Embodiment

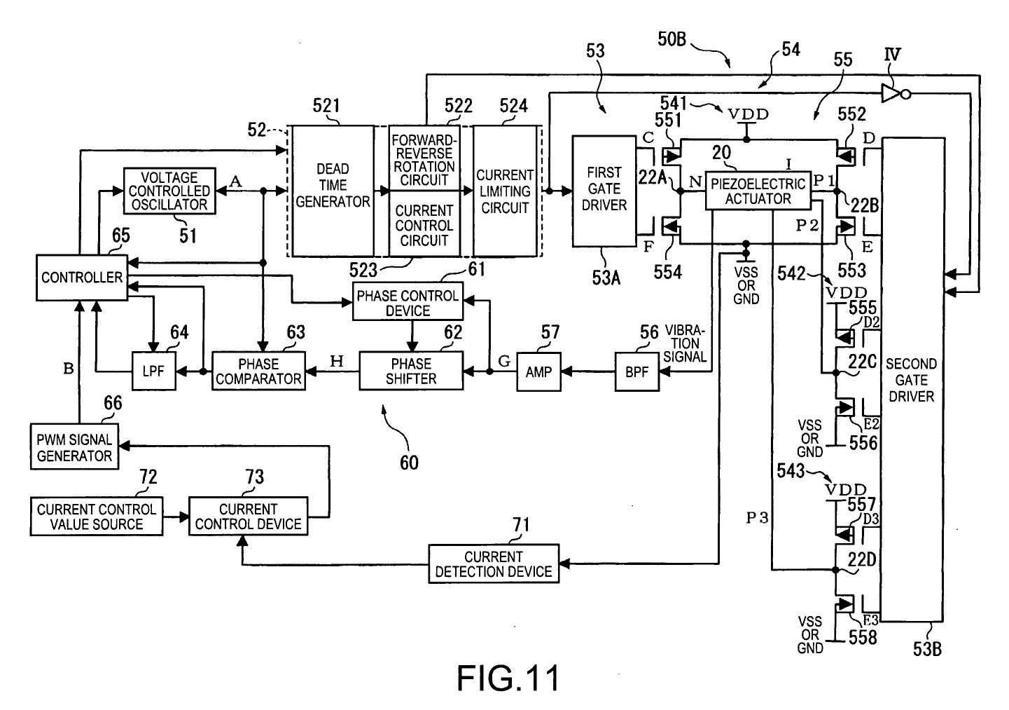

A third embodiment of the invention is described next with reference to FIG. 11.

The first and second embodiments of the invention apply drive control for driving the piezoelectric actuator 20 with high efficiency. This embodiment differs in that drive control enables controlling how much the driven body that is driven by the piezoelectric actuator 20 is driven.

FIG. 11 shows a drive control device 50B according to this embodiment of the invention.

This drive control device 50B differs from the drive control device 50 shown in FIG. 4 by additionally comprising a current detection device 71 for detecting current flow to the piezoelectric actuator 20 portion, a current control value source 72 for outputting a current control value, and a current control device 73 for outputting a control signal to the PWM signal generator 66 based on the current control value output from the current control value source 72 and the current value output by the current detection device 71.

The PWM signal generator 66 determines the pulse width of the control pulse signal based on the output from the current control device 73. More specifically, the PWM signal generator 66 uses feedback control based on the piezoelectric actuator 20 current in this embodiment of the invention.

In addition to the effects of the above embodiments, this embodiment of the invention affords the following effects.

(9) The pulse width of the control pulse signal output by the PWM signal generator 66 is adjustable based on the current flow of the piezoelectric actuator 20. The vibration state of the piezoelectric actuator 20 can therefore be controlled, and driving the driven body (the rotor speed when the driven body is a rotor) can be controlled, by adjusting the pulse width. The piezoelectric actuator 20 can therefore be used to drive driven bodies that require adjustable speed control, and driven bodies that require torque control. Controlling the speed (or torque) of the driven body by means of the piezoelectric actuator 20 can also be used to suppress the sound of the gears meshing when drive power is transferred to the gears 41 and 42, and thus also contributes to quieter operation.

Current feedback can also be used to assure stable piezoelectric actuator 20 drive control.

### Fourth Embodiment

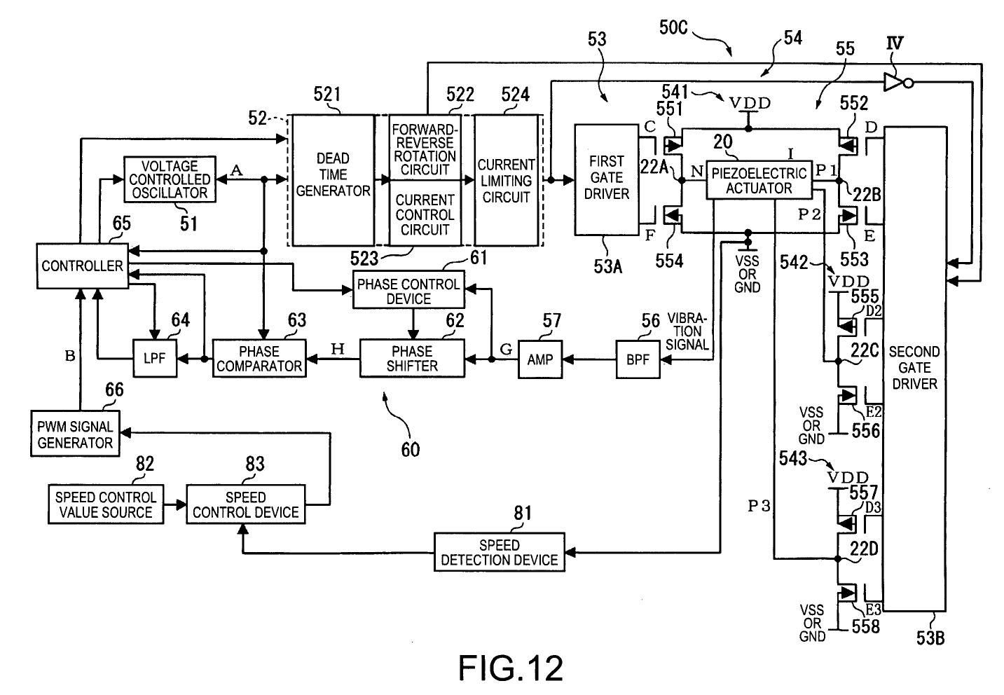

A fourth embodiment of the invention is described next with reference to FIG. 12.

This embodiment of the invention uses a different means than the third embodiment of the invention to control the piezoelectric actuator 20 to adjust the speed of a rotor as the driven body similarly to the third embodiment.

FIG. 12 shows a drive control device 50C according to this embodiment of the invention.

This drive control device 50C differs from the drive control device 50 shown in FIG. 4 by additionally comprising a speed detection device 81 for detecting the speed of the rotor, a speed control value source 82 for outputting a speed control value, and a speed control device 83 for outputting a control signal to the PWM signal generator 66 based on the speed detected by the speed detection device 81 and the speed control value output by the speed control value source 82.

The speed detection device 81 comprises, for example, the rotation sensor 15 for detecting rotation of the gear 41 (FIG. 2) that is rendered in unison with the rotor 30.

In addition to the effects of the first and second embodiments, this embodiment of the invention affords the following effects.

(10) The PWM signal generator 66 controls operation based on current flow to the piezoelectric actuator 20 in the third embodiment of the invention, but because the piezoelectric actuator 20 rotationally drives the rotor 30 by means of friction, slippage can occur. Error can therefore result with control based only on current. This embodiment of the invention directly detects the speed of the rotor 30 or gear 41, however, and therefore affords more accurate drive control.

### Fifth Embodiment

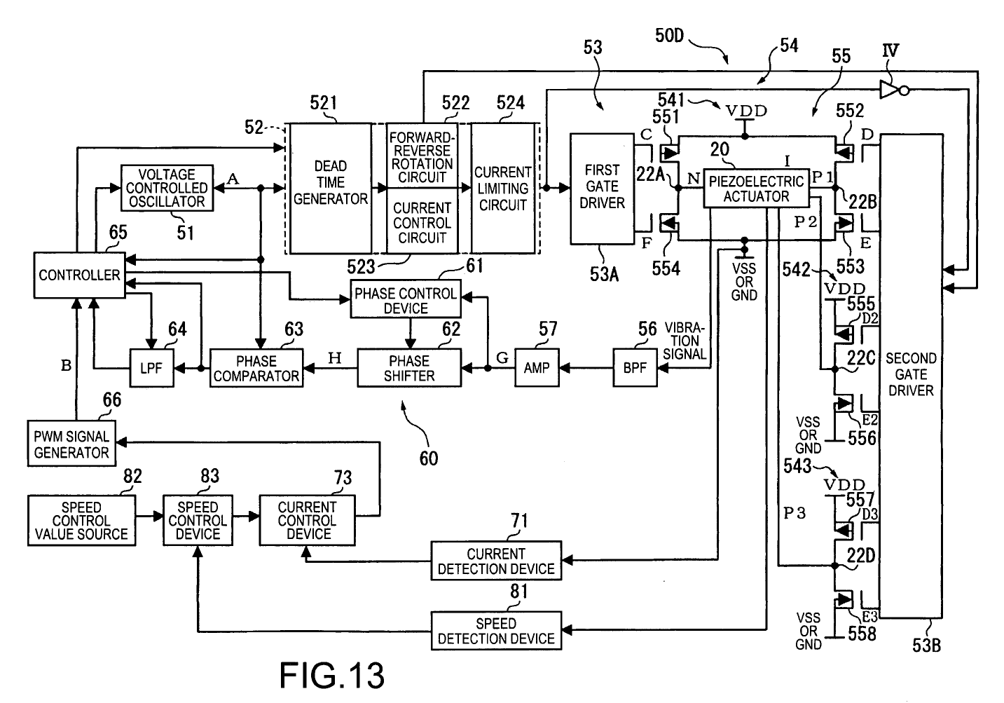

A fifth embodiment of the invention is described next with reference to FIG. 13.

The drive control device 50D according to this fifth embodiment of the invention combines drive control based on current as in the third embodiment of the invention, and drive control based on speed as in the fourth embodiment of the invention.

More specifically, the drive control device 50D of this embodiment of the invention comprises a current detection device 71, current control device 73, speed detection device 81, speed control value source 82, and speed control device 83.

The speed control device 83 outputs a current control value to the current control device 73 based on the speed control value from the speed control value source 82 and the speed detected by the speed detection device 81.

The current control device 73 outputs a control signal to the PWM signal generator 66 based on the current control value from the speed control device 83 and the current detected by the current detection device 71.

Feedback control in this embodiment of the invention therefore includes a control loop based on the rotor speed as a major loop, and a control loop based on current as a minor loop.

In addition to the effects of the first to fourth embodiments, this embodiment of the invention affords the following effects.

(11) Rotor speed (rotational velocity) can be controlled more accurately because the vibration state of the piezoelectric actuator 20 is controlled based on two parameters, the speed of the rotor 30 that is rotationally driven by the piezoelectric actuator 20 and the current flow through the piezoelectric actuator 20.

### Sixth Embodiment

A sixth embodiment of the invention is described next.

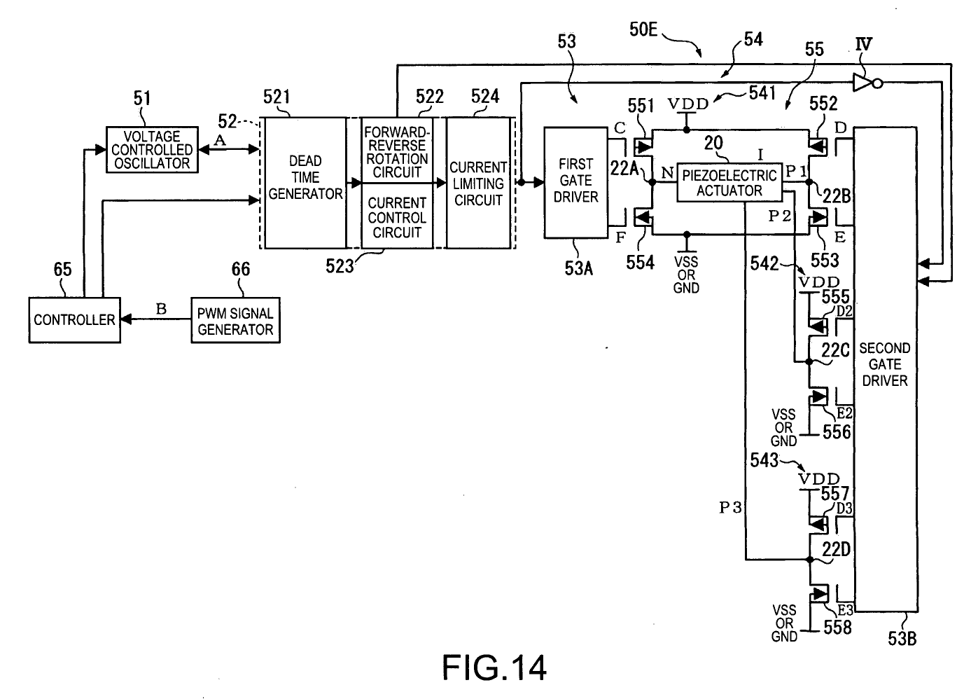

FIG. 14 shows a drive control device 50E according to this embodiment of the invention.

This drive control device 50E does not have the phase shift device, phase comparator, or lowpass filter described above, but is otherwise identical to the drive control device 50 described in the first embodiment.

This embodiment does not use phase control as described in the previous embodiments, but does not differ from the previous embodiments in the ability to change the ratio between the pulse width selection periods (t-n, t-w, t-m) by inputting the control pulse signal B from the PWM signal generator 66 through controller 65 to the pulse control circuit 52 to control the piezoelectric actuator current and rotor drive state desirably.

This embodiment of the invention thus affords the same effects as the first and second embodiments of the invention.

In addition, this embodiment enables further simplifying the arrangement of the drive control device.

### Seventh Embodiment

A seventh embodiment of the invention is described next. The previous embodiments describe drive control for a piezoelectric actuator assembled in a timepiece. This embodiment, however, describes drive control for a piezoelectric actuator assembled in a printer.

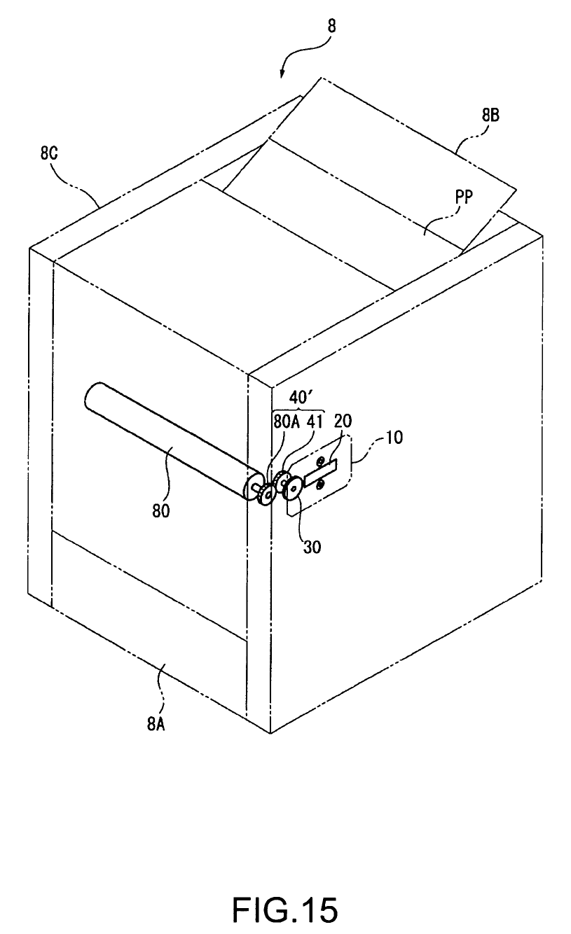

FIG. 15 is a schematic diagram of a printer 8 according to this embodiment of the invention. This printer 8 has a drawer-like paper tray 8A for holding printing paper, an output tray 8B for receiving the printed paper PP, and a roller 80 rendering a paper transportation means inside the printer housing 8C.

The roller 80 conveys paper from the paper tray 8A to a printing drive unit not shown.

The drive mechanism for driving the roller 80 comprises the piezoelectric actuator unit 10 (FIG. 2, FIG. 3) described in the first embodiment of the invention, and drive power from the piezoelectric actuator 20 is transferred to a gear 80A fastened to the rotating shaft of the roller 80. Speed reducing gear train 40′ in this embodiment of the invention comprises gear 41 in the piezoelectric actuator unit 10 and gear 80A.

As in the preceding embodiments of the invention, the drive electrode 221, 222, 223 rendered to the piezoelectric elements 22 are used selectively to drive the rotor 30 in both forward and reverse directions so that the paper can be conveyed in both forward and reverse directions.

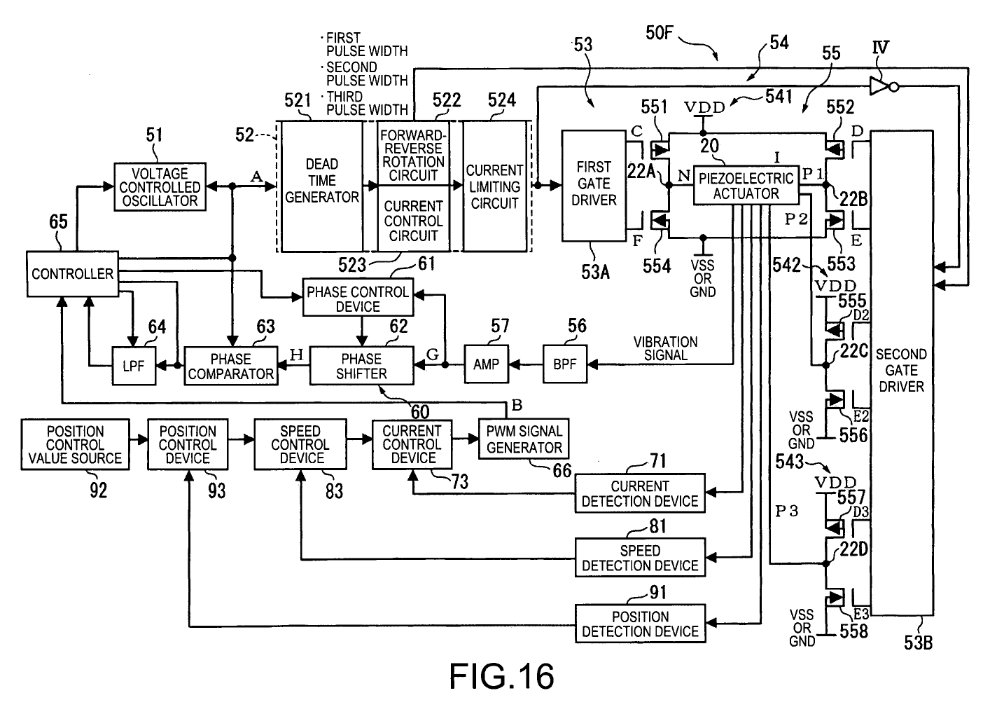

In addition to drive control based on current and speed as applied by the drive control device 50D in the fifth embodiment of the invention (FIG. 13), the drive control device 50F shown in FIG. 16 also controls the position of the rotor 30.

To enable this position control, the drive control device 50F has a position detection device 91 for detecting the position of the rotor, a position control value source 92 for outputting a position control value, and a position control device 93 for outputting a control signal to the speed control device 83 based on the rotor position detected by the position detection device 91 and the position control value input from the position control value source 92.

The position detection device 91 comprises a rotary encoder, for example, disposed opposite the gear 41 rendered in unison with the rotor 30 (FIG. 2) for detecting the position of the gear 41 and rotor 30, and detects the position of the rotor 30 based on the detected speed.

The paper feed distance contained in the printing control information externally input to the printer 8 is applied through the printing drive control unit to the position control value source 92, and the position control value source 92 outputs this paper feed distance as the control value to the position control device 93. The printing drive control unit not shown converts the paper feed distance from the printing control information to the output value (count) of the position detection device 91.

In this embodiment of the invention the control value from the position control value source 92 and the rotor 30 position detected by the position detection device 91 are input to the position control device 93, and the position control device 93 outputs a position control value determined from this input to the speed control device 83.

The speed control device 83 outputs a speed control value based on the position control value of the position control device 93 and the current detected by the current control device 73 to the current control device 73, and the current control device 73 outputs a current control value based on the speed control value and current detected by the current detection device 71 to the PWM signal generator 66. The PWM signal generator 66 inputs control pulse signal B to the controller 65 based on the current control value of the current control device 73.

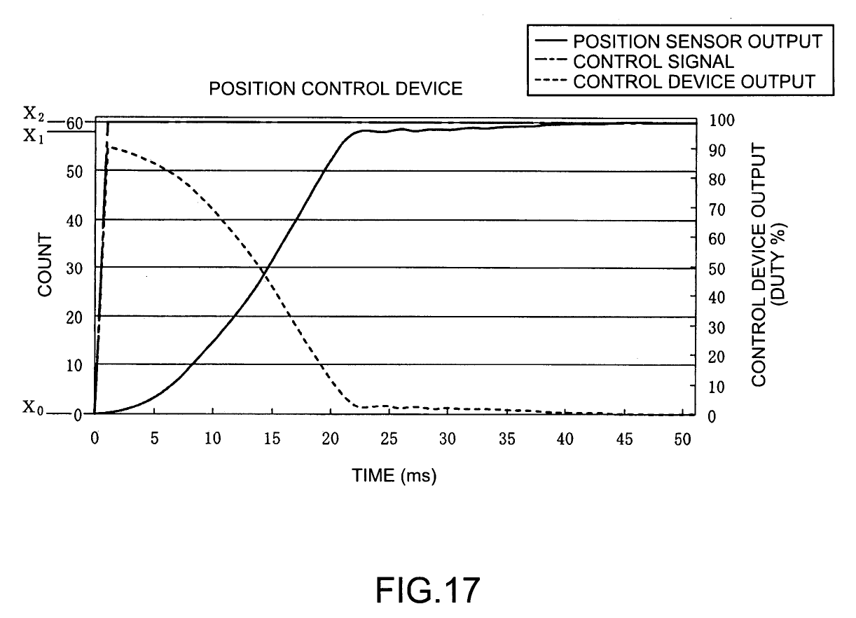

FIG. 17 shows the operation control signal (dotted line in FIG. 17) output from the position control device 93 to the controller 65 as an example of paper feed control in the printer 8 according to this embodiment of the invention. In FIG. 17 the x-axis shows the response time from when control starts, and the y-axis shows the rotor 30 position. As shown in FIG. 17, when the paper feed distance control value (a count of 60 denoted by the dot-dash line in FIG. 17) is input, the output (duty %) of the position control device 93 is substantially maximum. Output from the position control device 93 then drops as the rotor 30 moves from control start position X₀ to target position X₂, and the rotor 30 is stopped at target position X₂.

The output of position control device 93 can be variably controlled based on rotor 30 position feedback by switching the ratio between the selection periods t-n, t-m, and t-w of the first pulse width (Nr), second pulse width (Md), and third pulse width (Wd) (FIG. 10) in specified period t.

More specifically, as shown in FIG. 17, the duty ratio (%) of the position control device 93 output goes from 0% before control starts to substantially 100% as soon as the control value is input, and thus starts driving the piezoelectric actuator 20 at high speed. The duty ratio then drops gradually to near 0%, slowing the speed of the rotor 30 to reduce the inertia of the rotor 30 at position X₁ near the target position X₂ and prevent vibration. The rotor 30 is then driven and positioned from this proximal position X₁ at an approximately 10% duty ratio, and stopped at target position X₂. By thus controlling the speed, the meshing sound of the gear 41 in the piezoelectric actuator unit 10 and the gear 80A of the roller 80 can be suppressed.

This embodiment of the invention affords the following effects in addition to the effects of the first to fifth embodiments described above.

(12) The speed of the rotor 30 can be controlled even more accurately by controlling vibration of the piezoelectric actuator 20 based on three parameters, specifically, the speed of the rotor 30 that is driven rotationally by the piezoelectric actuator 20, the position of the rotor 30, and the current flowing through the piezoelectric actuator 20.

(13) Because the drive control device 50F provides speed control, the drive control device 50F can be used in the paper feed mechanism of a printer 8 that requires high positioning precision. The printer size and cost can also be reduced because the piezoelectric actuator unit 10 is thin and compact, and the circuit design is simple.

(14) Paper feed response and positioning precision can be improved, and quieter operation can be achieved, because drive control based on three values, specifically first to third pulse widths, affords a more linear drive characteristic and more accurate speed control.

### Variations of the Invention

The present invention is not limited to the embodiments described above, and includes variations and improvements that can be achieved within the scope of the accompanying claims.

### First Variation

The piezoelectric actuator 20 is rendered as a piezoelectric actuator unit 10 that drives the chronograph seconds hand 7A or roller 80 by rotation of the intervening rotor 30 and gear 41 assembled in the unit 10 in the foregoing embodiments of the invention, but the piezoelectric actuator 20 could drive the chronograph seconds hand 7A or roller 80 directly.

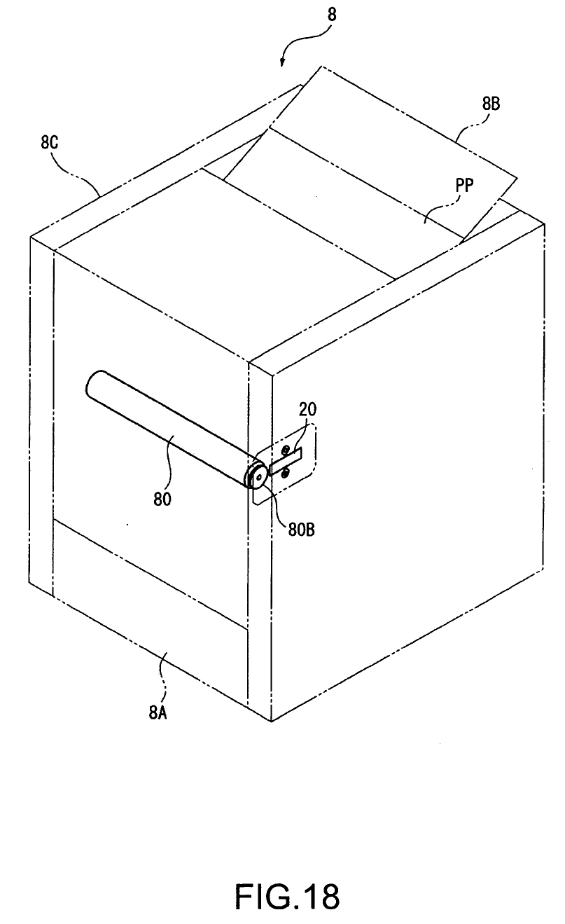

FIG. 18 shows an example of a piezoelectric actuator 20 assembled in a printer 8 so that the contact part 25 of the piezoelectric actuator 20 contacts the side of the rotating shaft 80B of the roller 80 directly. The high torque produced by the piezoelectric actuator enables using the piezoelectric actuator to directly drive the driven body without using an intervening rotor 30 and speed reducing gear train 40.

The piezoelectric actuator 20 is described above as having a three-layer structure with one piezoelectric element 22 bonded to both front and back sides of the reinforcing plate 21, but the invention is not so limited. More particularly, the piezoelectric actuator 20 can have a two-layer structure with only one piezoelectric element 21 bonded to only one side of the reinforcing plate 21. Furthermore, two to ten or even more piezoelectric elements can be bonded to both front and back sides of the reinforcing plate 21 to render a piezoelectric actuator with a multilayer oscillator that produces even greater torque and is therefore even better suited to direct drive applications. Direct drive applications also afford even quieter operation because no gears or other intervening members are involved.

### Second Variation

The piezoelectric actuator described above has a flat, rectangular oscillator, but the arrangement of the piezoelectric actuator is not so limited and the drive control device and drive control method of the invention can be applied to piezoelectric actuators having a substantially annular oscillator. The electromechanical coupling coefficient of the piezoelectric element is greater in a piezoelectric actuator that uses an annular piezoelectric element than a piezoelectric element that has a rectangular or other shape with a long dimension, and thus produces greater output relative to size.

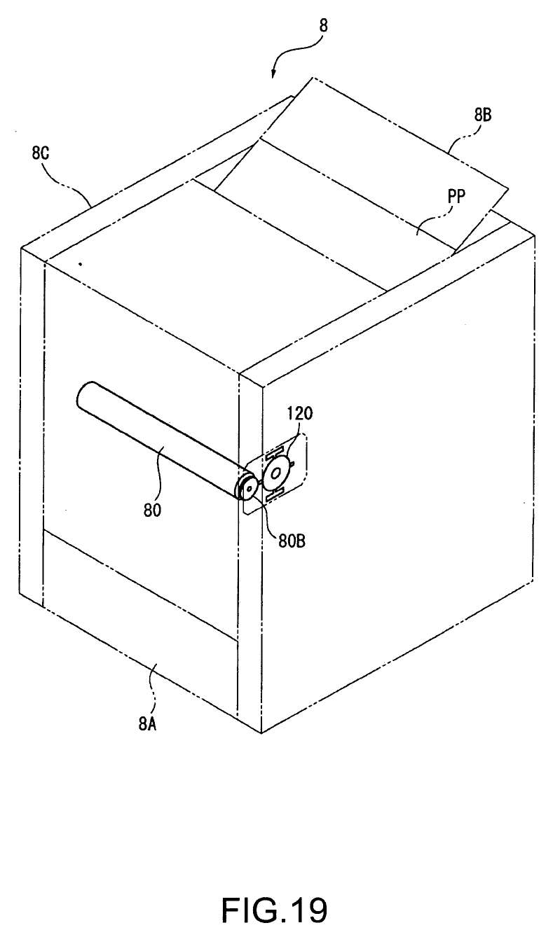

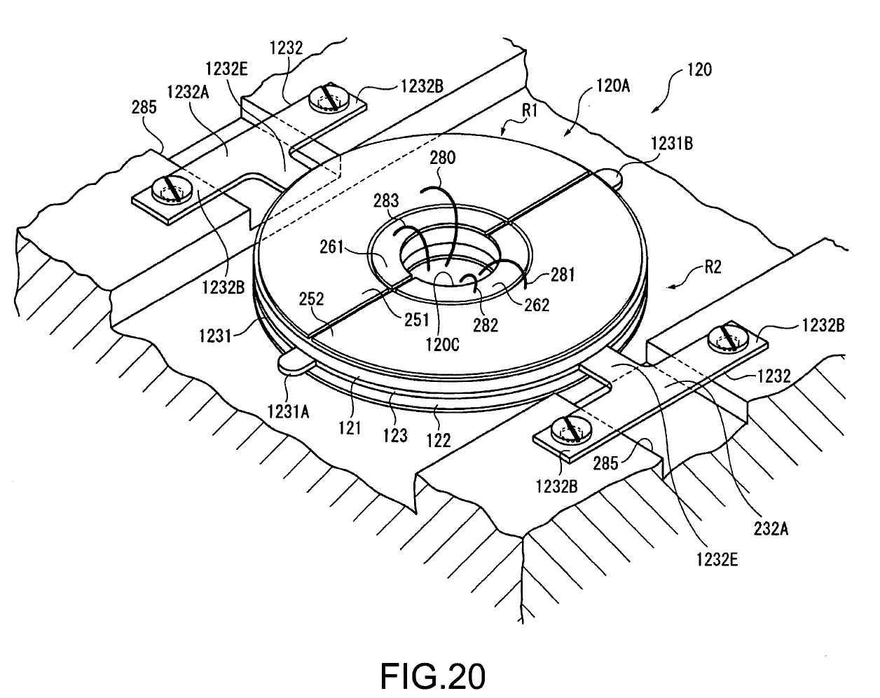

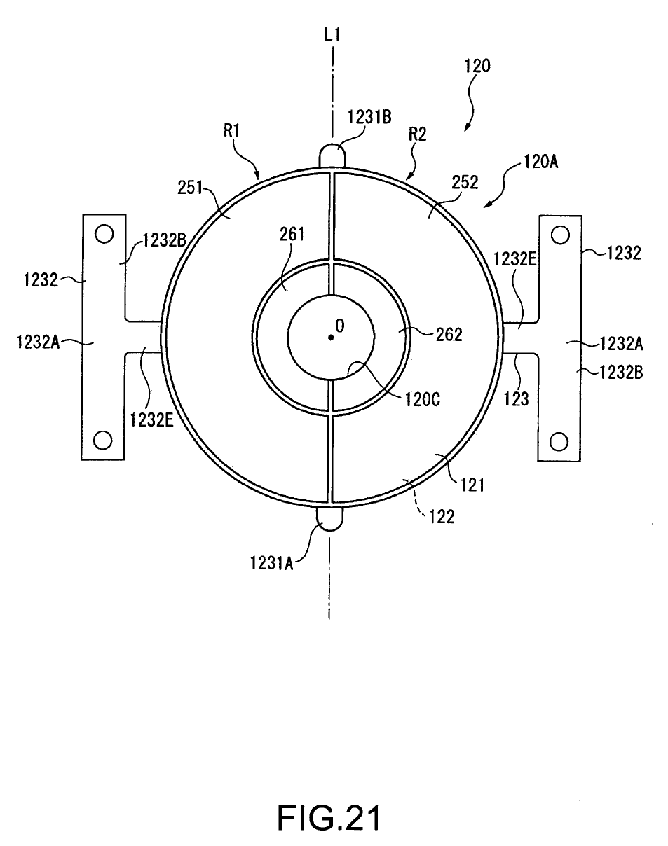

FIG. 19 shows an annular piezoelectric actuator 120 assembled in a printer 8, and FIG. 20 and FIG. 21 are an oblique view and plan view of the piezoelectric actuator 120.

The piezoelectric actuator 120 comprises an annular oscillator 120A with a hole 120C in the center, and has piezoelectric elements 121 and 122 disposed on the front and back sides of a reinforcing plate 123.

The piezoelectric actuator 120 has a substantially semicircular first vibration region R1 and a substantially semicircular second vibration region R2 separated by a two segment line L1 through the diameter of the piezoelectric actuator 120 (see FIG. 21) as regions to which drive signals with a specific phase difference are applied.

An arc-shaped drive electrode 251 to which the drive signal is applied, and a detection electrode 261 rendered on the inside circumference side of the drive electrode 251 for detecting the vibration state of the oscillator 120A, are disposed in the first vibration region R1 on the surface of piezoelectric elements 121 and 122. A similar drive electrode 252 and detection electrode 262 are disposed line symmetrically to drive electrode 251 and detection electrode 261 on the opposite side of two-segment line L1 in the second vibration region R2.

A first vibration region R1 and second vibration region R2 identical to those formed on the front piezoelectric element 121 are also rendered on the piezoelectric element 122 on the back side of the piezoelectric actuator as shown in FIG. 20, and a drive electrode 251 and detection electrode 261 are disposed in the first vibration region R1, and a drive electrode 252 and detection electrode 262 are disposed in the second vibration region R2. Conductivity between the electrodes on piezoelectric element 122 and the electrodes on piezoelectric element 121 is provided by wires or other means. Drive electrode 252 is thus disposed behind drive electrode 251, and these drive electrodes are electrically connected to each other so that the same drive signal is applied to both and both drive electrodes 251 and 252 expand and contract simultaneously.

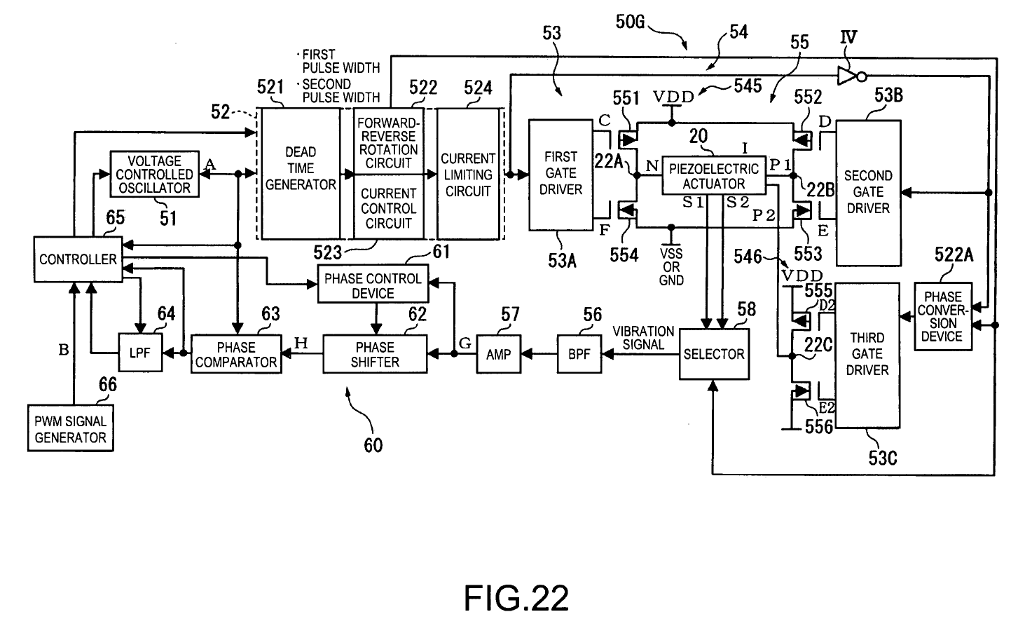

The drive electrodes 251, 252 and detection electrodes 261, 262 are connected to drive control device 50G (FIG. 22) by conductors 280, 281, 282, 283 passing through hole 120C.

The reinforcing plate 123 is made from stainless steel or other conductive material, and comprises an annular main ring 1231 to which the piezoelectric elements 121 and 122 are bonded, and a pair of supporting fastener portions 1232 rendered in unison with and supporting the main ring 1231 so that the main ring 1231 can vibrate. This reinforcing plate 123 is a common electrode for the drive electrodes 251, 252 and detection electrodes 261, 262 of the piezoelectric elements 121 and 122, and is connected to ground (GND).

Contact parts 1231A and 1231B are formed at the opposite ends of two-segment line L1 projecting from the main ring 1231 in line with two-segment line L1. One contact part 1231A contacts the side of the rotating shaft 80B of the paper feed roller 80, and the contact parts 1231A and 1231B are positioned on a normal line to the outside circumference of the rotating shaft 80B.

The supporting fastener portions 1232 have stationary portions 1232B that are fastened by screws to a base mounted inside the printer 8, and a vibration part 1232A. The vibration part 1232A can vibrate freely by means of recess 285 and neck portion 1232E rendered on the outside part of the main ring 1231 at a position substantially perpendicular to the two-segment line L1.

FIG. 22 is a block diagram of the drive control device 50G in this variation of the invention. The drive control device 50G generates and supplies two drive signals of different phase to drive electrode 251 and drive electrode 252, and comprises first gate driver 53A (node 22A) connected to reinforcing plate 123, second gate driver 53B (node 22B) connected to drive electrode 251, and third gate driver 53C (node 22C) connected to drive electrode 252. Disposed to the first, second, and third gate drivers 53A, 53B, 53C, respectively, are switches 551, 554, switches 552, 553, and switches 555, 556. Power supplies 545 and 546 used for advancing the paper in forward and reverse directions are also provided.

These switches 551 to 554 (or switches 551, 555, 556, 554) are bridge connected to the piezoelectric elements 121 and 122 by means of first gate driver 53A, second gate driver 53B, and third gate driver 53C.

The switch circuit rendered by the pair of switches 551, 553 (or switches 551, 556) at diagonally opposite parts of the bridge, and the switch circuit rendered by the pair of switches 552, 554 (or switches 555, 554) are alternately switched on/off. As a result, the specific supply voltage applied by the power supply 54 is converted to an alternating rectangular wave voltage and applied to the piezoelectric actuator 120. In other words, power supplies 545, 546 apply an alternating voltage to the piezoelectric elements 121, 122 between the drive electrodes 251 and 252 and reinforcing plate 123 to drive the rotor 30.

This drive control device 50G also has a phase conversion device 522A for shifting the phase of the reference pulse signal input from the pulse control circuit 52 to the third gate driver 53C, and a selector 58 for selecting either detection electrode 261 or detection electrode 262 to detect vibration of the piezoelectric actuator 120.

Other aspects of the arrangement of this drive control device 50G are substantially the same as the drive control device 50 described in the first embodiment of the invention.

The phase conversion device 522A is a phase shifter that changes the direction of the phase shift based on the control signal input from the forward-reverse rotation circuit 522.

Signal input to the first gate driver 53A is output directly from the pulse control circuit 52, but the signal input to the second gate driver 53B has the voltage level inverted by inverter IV. The signal output from the pulse control circuit 52 passes through phase conversion device 522A before being input to the third gate driver 53C, and the phase of the signal output from the pulse control circuit 52 is shifted a specific angle by the phase conversion device 522A.

The phase shift of the phase conversion device 522A is 90 degrees in this embodiment of the invention, and the sign of the phase shift switches positive or negative according to a control signal from the forward-reverse rotation circuit 522.

When a command for conveying the paper in the forward direction is input, the forward-reverse rotation circuit 522 inputs a control signal for driving the rotor 30 in the forward rotation direction to the phase conversion device 522A and selector 58. When a command for conveying the paper in the reverse direction is input, the forward-reverse rotation circuit 522 inputs a control signal for driving the rotor 30 in the reverse rotation direction to the phase conversion device 522A and selector 58.

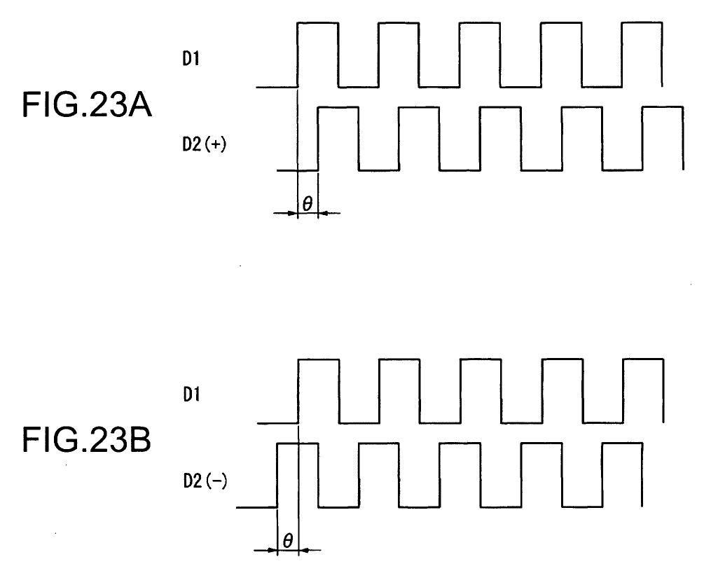

FIG. 23A shows the signal D1 input to the first and second gate drivers 53A, 53B and the signal D2 (+) input to the third gate driver 53C when rotor 30 rotation is forward. When the phase of signal D1 is 0 degrees, the phase shift of the phase conversion device 522A is +90 degrees.

FIG. 23B shows the signal D1 input to the first and second gate drivers 53A, 53B and the signal D2 (−) input to the third gate driver 53C when rotor 30 rotation is reverse. When the phase of signal D1 is 0 degrees, the phase shift of the phase conversion device 522A is −90 degrees.

A drive phase shift of +90 degrees or −90 degrees is thus applied between signal D1 and signal D2 (+ or −), and the vibration behavior of the first and second vibration regions R1, R2 of the piezoelectric actuator 120 to which signals D1 and D2 are supplied varies according to this drive phase shift.

When the control signal input from the forward-reverse rotation circuit 522 causes the piezoelectric actuator 120 to operate in the forward mode and the phase of the first vibration region R1 is therefore delayed to the phase of the second vibration region R2, the selector 58 outputs detection signal S1 from detection electrode 261 to the bandpass filter 56. When operating in the reverse mode and the phase of the second vibration region R2 is delayed, the selector 58 outputs detection signal S2 from detection electrode 262 to the bandpass filter 56.

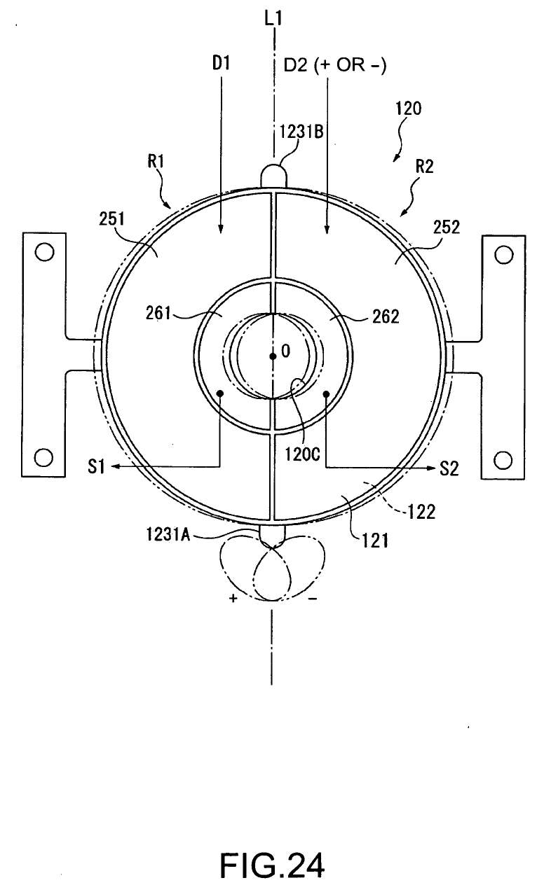

The operation of the piezoelectric actuator 120 is described next with reference to FIG. 24. The piezoelectric actuator 120 is activated by a paper feed command, and drive signals D1 and D2 (+) with a positive phase difference, or drive signals D1 and D2 (−) with a negative phase difference, are supplied through the drive control device 50G to the first and second vibration regions R1 and R2 (see FIG. 23). This produces an electric field through the thickness of the piezoelectric elements 121 and 122, and excites the piezoelectric elements 121 and 122 and flexible reinforcing plate 123 to vibrate perpendicularly to the field, that is, to expand and contract radially to the piezoelectric elements 121 and 122. The antinodes of this axisymmetric vibration are across the entire circumferential surface of the oscillator 120A.

Because of the phase difference in drive signals D1 and D2 (+or −), the vibration behavior of the first vibration region R1 and the vibration behavior of the second vibration region R2 are asymmetric as indicated by the dot-dash line and double-dot-dash line shown in FIG. 24.

Because of this phase difference in the axisymmetric vibration of the first and second vibration regions R1 and R2, the first and second vibration regions R1 and R2 vibrate eccentrically to the center 0 of the piezoelectric actuator 120. More specifically, sinusoidal displacement in the direction substantially perpendicular to the two-segment line L1 causes the hole 120C in the center of the piezoelectric actuator 120 to move bidirectionally to both sides of the two-segment line L1 through center 0.

The piezoelectric actuator 120 is thus excited in a mixed mode combining axisymmetric vibration with sinusoidal vibration, and thus vibrates in a nearly resonant state.

When the positive phase difference drive signal D1, D2 (+) are supplied to first and second vibration regions R1 and R2, that is, when phase-advanced drive signal D1 is supplied to first vibration region R1 and phase-delayed drive signal D2 (+) is supplied to second vibration region R2, the vibration path of contact part 1231A is the (+) elliptical path biased to the two-segment line L1 shown in FIG. 24. The rotor 30 is intermittently driven on a tangent to this vibration path, and the rotating shaft 80B of the roller 80 rotates forward at a specific speed as a result of the contact part 1231A continuing this elliptical motion at a specific drive frequency.

Conversely, when the negative phase difference drive signal D1, D2 (−) are supplied to first and second vibration regions R1 and R2, that is, when the phase-delayed drive signal is supplied to first vibration region R1 and phase-advanced drive signal is supplied to second vibration region R2, the vibration path of contact part 1231A is the (−) elliptical path biased to the two-segment line L1 in the opposite direction as the (+) elliptical path as shown in FIG. 24. This (−) path and the (+) path are line symmetrical to the two-segment line L1 and turn in opposite directions and thus cause the rotating shaft 80B to turn in opposite directions.

This embodiment of the invention affords the same effects the previous embodiments of the invention.

This embodiment of the invention is described driving the rotating shaft 80B directly, but the invention is not so limited. More particularly, the piezoelectric actuator 120 can be rendered as a unit with the rotor 30 and speed reducing gear train 40, for example, similarly to the piezoelectric actuator unit 10 of the seventh embodiment to transfer drive power to a gear disposed to the paper feed roller 80. The piezoelectric actuator 120 of this embodiment can also be used to drive the hands of an electronic timepiece 1 as described in the first embodiment of the invention.

Piezoelectric actuator drive control according to the present invention has been described using different piezoelectric actuators and electronic devices, but how much a driven body is driven and the current level controlling the vibration state of the piezoelectric actuator that are referenced to determine the pulse width that is selected as the pulse width of the drive pulse signal are not limited to what is described in these embodiments. More specifically, the actual values of the first pulse width, second pulse width, and third pulse width are not limited to the values described in these embodiments of the invention.

The speed of the rotor 30 can be freely adjusted in these embodiments of the invention by changing the ratio of the periods t-n, t-w, and t-m that each pulse width setting is selected as the pulse width of the drive pulse signal in specified period t. It will be obvious that the ratio between the pulse width selection periods t-n, t-w, t-m of the drive pulse signal can also be adjusted to maintain a particular piezoelectric actuator vibration state and thereby maintain a particular driven body drive state when the drive frequency required to drive the piezoelectric actuator desirably changes as a result of a change in temperature, load, or other drive conditions.

These embodiments of the invention describe using two or three different pulse width settings, but four, five, or more pulse width settings can be used by arranging the control signal source to output a control signal with more voltage levels.

Except for the specific arrangement of the piezoelectric actuator 20 and the parts of the drive control device 50 that are essential to the present invention, other parts of these embodiments, such as the voltage controlled oscillator 51 and switches 551 to 558, can be suitably varied according to the specific implementation.

The pulse width selection means inserts dead time in these embodiments of the invention, but the pulse width selection means and means for generating dead time can be rendered using separate circuits or even in software.

The present invention is also not limited to being used in timepieces, and is suitable for use in various electronic devices, particularly portable electronic devices for which small size is essential.

Examples of such electronic devices include telephones with a clock function, cell phones, contactless IC cards, notebook computers, personal digital assistants (PDA), and cameras.

The invention can also be used in cameras that do not have a clock function, in digital cameras, video cameras, cell phones with a built-in camera function, and other electronic devices. When used in an electronic device with a camera function, the drive means of the present invention can be used to drive the lens focusing mechanism, zoom mechanism, and aperture control mechanism.

The drive means of the present invention can also be used in the meter needle drive mechanism of measuring instruments, the drive mechanism of movable toys, the meter needle drive mechanism for the instrument panel of an automobile, piezoelectric buzzers, inkjet printer heads, the paper feed mechanism in printers, the drive mechanism in toys such as dolls and riding toys, ultrasonic motors, and other applications.

The piezoelectric actuator in these embodiments of the invention is used for driving the hands to indicate the time in an electronic timepiece 1, but the invention is not so limited and the piezoelectric actuator can be used to drive the date display mechanism in an electronic timepiece 1.

The type of timepiece is also not limited to a wristwatch, and could be a pocket watch, a wall clock, or a mantle clock, for example. The invention can also be used in the mechanism for driving the works of a cuckoo clock, for example, in such timepieces.

The best modes and methods of achieving the present invention are described above, but the invention is not limited to these embodiments. More specifically, the invention is particularly shown in the figures and described herein with reference to specific embodiments, but it will be obvious to one with ordinary skill in the related art that the shape, material, number, and other detailed aspects of these arrangements can be varied in many ways without departing from the technical concept or the scope of the objective of this invention.

Therefore, description of specific shapes, materials and other aspects of the foregoing embodiments are used by way of example only to facilitate understanding the present invention and in no way limit the scope of this invention, and descriptions using names of parts removing part or all of the limitations relating to the form, material, or other aspects of these embodiments are also included in the scope of this invention.

The entire disclosure of Japanese Patent Application Nos:2005-240013, filed Aug. 22, 2005 and 2006-140248, filed May 19, 2006 are expressly incorporated by reference herein.

What is claimed is:

1. A drive control device for a piezoelectric actuator that comprises an oscillator that has a piezoelectric element and vibrates by supplying a drive pulse signal to the piezoelectric element, and transfers vibration of the oscillator to a driven body, the drive control device comprising:
a pulse width selection means for selectively switching the pulse width of a substantially constant frequency drive pulse signal between a plurality of predetermined pulse width settings,
wherein the plural pulse width settings include a first pulse width for setting the driven body or piezoelectric actuator to a first drive state, and a second pulse width for setting the driven body or piezoelectric actuator to a second drive state that is different from the first drive state, and
the pulse width selection means can vary a ratio between a first pulse width selection period in which the first pulse width is selected and a second pulse width selection period in which the second pulse width is selected in a specified period.

2. The piezoelectric actuator drive control device described in claim 1, wherein:
the plural pulse width settings include a third pulse width for setting the driven body or piezoelectric actuator to a third drive state that is different from the first drive state and the second drive state;
the pulse width selection means switches between the first pulse width and the third pulse width in a specified period, and between the second pulse width and third pulse width in a specified period; and
the ratio in the specified period between the first pulse width selection period and a third pulse width selection period in which the third pulse width is selected, and the ratio in the specified period between the second pulse width selection period and the third pulse width selection period in which the third pulse width is selected, are variable.

3. The piezoelectric actuator drive control device described in claim 1, further comprising:
a control signal source for inputting a control signal to the pulse width selection means;
wherein the control signal is generated at one of a plurality of voltage levels, and
the pulse width setting is selected according to the control signal voltage.

4. The piezoelectric actuator drive control device described in claim 1, further comprising:
a first switching means connected between one terminal of the piezoelectric element and a high voltage unit;
a second switching means connected between the other terminal of the piezoelectric element and the high voltage unit;
a third switching means connected between the other terminal of the piezoelectric element and a low voltage unit;
a fourth switching means connected between the one terminal of the piezoelectric element and the low voltage unit; and
a gate driver for controlling the first to fourth switching means;
wherein the gate driver applies an alternating drive voltage to the piezoelectric element by switching between a state applying a charge of a first direction to the piezoelectric element by turning the first and fourth switching means on and the second and third switching means off, and a state applying a charge of a second direction opposite the first direction to the piezoelectric element by turning the first and fourth switching means off and the second and third switching means on; and
the pulse width selection means generates dead time that is inserted to the drive pulse signal period, and can vary the dead time so that the drive pulse signal is output at the set pulse width, in order to suppress shoot-through current resulting from the first switching means and fourth switching means being simultaneously conductive to one terminal of the piezoelectric element, and to suppress shoot-through current resulting from the second switching means and third switching means being simultaneously conductive to the other terminal of the piezoelectric element.

5. The piezoelectric actuator drive control device described in claim 1, wherein:
the oscillator excites an elliptical vibration by combining two vibration modes; and
the drive signal is single phase.

6. An electronic device comprising:
a piezoelectric actuator;
a driven body driven by the piezoelectric actuator; and
the piezoelectric actuator drive control device described in claim 1.

7. The electronic device described in claim 6, wherein the electronic device is a timepiece comprising a timekeeping unit, and a time information display unit for displaying the time information kept by the timekeeping unit.

8. A drive control method for a piezoelectric actuator that comprises an oscillator that has a piezoelectric element and vibrates by supplying a drive pulse signal to the piezoelectric element, and transfers vibration of the oscillator to a driven body, the drive control method comprising steps of:
selectively switching the pulse width of a substantially constant frequency drive pulse signal between a plurality of predetermined pulse width settings,
wherein the plural pulse width settings include a first pulse width for setting the driven body or piezoelectric actuator to a first drive state, and a second pulse width for setting the driven body or piezoelectric actuator to a second drive state that is different from the first drive state; and
varying the ratio between a first pulse width selection period in which the first pulse width is selected and a second pulse width selection period in which the second pulse width is selected in a specified period.

9. The piezoelectric actuator drive control method described in claim 8, wherein:
the plural pulse width settings include a third pulse width for setting the driven body or piezoelectric actuator to a third drive state that is different from the first drive state and the second drive state;
the pulse width selection means switches between the first pulse width and the third pulse width in a specified period, and between the second pulse width and third pulse width in a specified period; and
the ratio in the specified period between the first pulse width selection period and a third pulse width selection period in which the third pulse width is selected, and the ratio in the specified period between the second pulse width selection period and the third pulse width selection period in which the third pulse width is selected, are variable.

10. The piezoelectric actuator drive control method described in claim 8, wherein:
the control signal is generated at one of a plurality of voltage levels, and the pulse width setting is selected according to the control signal voltage.

11. The piezoelectric actuator drive control method described in claim 8, comprising:
a first switching means connected between one terminal of the piezoelectric element and a high voltage unit;
a second switching means connected between the other terminal of the piezoelectric element and the high voltage unit;
a third switching means connected between the other terminal of the piezoelectric element and a low voltage unit;
a fourth switching means connected between the one terminal of the piezoelectric element and the low voltage unit; and
a gate driver for controlling the first to fourth switching means;
wherein the gate driver applies an alternating drive voltage to the piezoelectric element by switching between a state applying a charge of a first direction to the piezoelectric element by turning the first and fourth switching means on and the second and third switching means off, and a state applying a charge of a second direction opposite the first direction to the piezoelectric element by turning the first and fourth switching means off and the second and third switching means on; and
the drive control method further comprising a step of:
varying the dead time so that the drive pulse signal is output at the set pulse width when generating dead time that is inserted to the drive pulse signal period in order to suppress shoot-through current resulting from the first switching means and fourth switching means being simultaneously conductive to one terminal of the piezoelectric element, and suppress shoot-through current resulting from the second switching means and third switching means being simultaneously conductive to the other terminal of the piezoelectric element.
